(19) United States
(12) Patent Application Publication
(10) Pub. No.: US 2025/0328294 A1
(43) Pub. Date: Oct. 23, 2025

(54) STORAGE MEDIUM THAT ENABLES USER TO USE PAGE CONTINUOUS COPY FUNCTION, METHOD OF CONTROLLING INFORMATION PROCESSING APPARATUS, AND INFORMATION PROCESSING APPARATUS

(71) Applicant: CANON KABUSHIKI KAISHA, Tokyo (JP)

(72) Inventor: TAKU SHINOHARA, Saitama (JP)

(21) Appl. No.: 19/178,022

(22) Filed: Apr. 14, 2025

(30) Foreign Application Priority Data
Apr. 17, 2024 (JP) 2024-066655

(51) Int. Cl. G06F 3/12

(52) U.S. Cl. CPC G06F 3/1205; G06F 3/1228

(57) ABSTRACT

A non-transitory computer-readable storage medium storing a program supporting a general-purpose program which can be commonly used for scanners of a plurality of makers. The program is executed to thereby execute a method of controlling an information processing apparatus in which the program is installed. A setting screen is displayed on a display unit of the information processing apparatus, for receiving a setting of a predetermined scan function that divides image data of a read image of one original into a plurality of image data and outputs the divided image data. A command for causing a scanner to execute scan processing based on the setting received on the setting screen is output.

### BACKGROUND OF THE INVENTION

### Field of the Invention

The present invention relates to a storage medium that enables a user to use a page continuous copy function, a method of controlling an information processing apparatus, and an information processing apparatus.

### Description of the Related Art

There is known a configuration that uses a scan driver installed in a host computer as software for controlling a scan device and instructs execution of scan processing to a scan device connected to the host computer. In the host computer, an operating system (OS) as basic software is installed, and the scan driver is configured according to specifications defined by the OS and operates when called by the OS. The maker that provides the scan device provides a scan driver adapted to the specifications of the OS, whereby it is possible to provide means for instructing execution of scan processing to the scan device using the OS.

Incidentally, in Windows (registered trademark), a standard class driver (hereinafter also referred to as the “standard driver”) which can be commonly used for scan devices of a plurality of makers is provided. The standard driver has been incorporated in the package of the OS and easily becomes available by connecting a desired scan device to the host computer. Therefore, it is unnecessary to separately install a scan driver specific to each model, which is adapted to the scan device, giving high convenience. Further, it is assumed that the standard driver is configured to enable a user to designate a scan function based on scan function information of a scan device connected to the host computer. With this, the user using the standard driver can designate a scan function according to the capabilities of the scan device connected to the host computer only by using one standard driver. However, this is limited to functions which can be realized only by the standard driver, and hence it is impossible to designate a function unique to a maker. On the other hand, as a technique for enabling a user to use a function unique to a maker, there has been proposed a technique in Japanese Laid-Open Patent Publication (Kokai) No. 2021-033526. Japanese Laid-Open Patent Publication (Kokai) No. 2021-033526 discloses a program that extends a print function of general-purpose software.

Here, the function unique to a maker includes a page continuous copy function of a scan device. The page continuous copy function is a function of generating, in processing for scanning a double-page spread of an original, such as a magazine and a book, two image data, by dividing the spread into right and left pages. In the page continuous copy function, it is possible to set a page order of image data to be output, specifically, which of image data items of right and left pages is set to image data of a preceding page, depending on the setting of an opening type. In a case where the original is a left-opening type, image data of a left page of the spread of the original is set as image data of the preceding page, and image data on a right page of the spread is set as image data of the following page. Further, in a case where the original is a right-opening type, image data on a right page of the spread of the original is set as image data of the preceding page, and image data on a left page of the spread is set as image data of the following page. By using the page continuous copy function, a user can obtain separate data items with respect to right and left pages of each double-page spread of a book, a magazine, or the like.

However, the standard driver does not support the page continuous copy function, and hence the host computer that instructs execution of scan processing to the scan device using the standard driver cannot enable a user to use the page continuous copy function.

### SUMMARY OF THE INVENTION

The present invention provides a storage medium that enables a user to use a page continuous copy function in a case where scanning is performed by using a general-purpose program which can be commonly used for scanners of a plurality of makers, a method of controlling an information processing apparatus, and an information processing apparatus.

In a first aspect of the present invention, there is provided a non-transitory computer-readable storage medium storing a program supporting a general-purpose program which can be commonly used for scanners of a plurality of makers, the program being executed to thereby execute a method of controlling an information processing apparatus in which the program is installed, the method including displaying, on a display unit of the information processing apparatus, a setting screen for receiving a setting of a predetermined scan function that divides image data of a read image of one original into a plurality of image data and outputs the divided image data, and outputting a command for causing a scanner to execute scan processing based on the setting received on the setting screen.

In a second aspect of the present invention, there is provided a method of controlling an information processing apparatus in which a program supporting a general-purpose program which can be commonly used for scanners of a plurality of makers has been installed, including displaying a setting screen for receiving a setting of a predetermined scan function that divides image data of a read image of one original into a plurality of image data, on a display unit of the information processing apparatus, and outputting a command for causing a scanner to execute scan processing based on the setting received on the setting screen.

According to the present invention, in a case where scanning is performed by using a general-purpose program which can be commonly used for scanners of a plurality of makers, a user is enabled to use the page continuous copy function.

Further features of the present invention will become apparent from the following description of exemplary embodiments (with reference to the attached drawings).

### BRIEF DESCRIPTION OF THE DRAWINGS

FIG. 1 is a block diagram schematically showing a hardware configuration of a communication system according to embodiments.

FIGS. 2A and 2B are block diagrams each schematically showing a software configuration of a host computer appearing in FIG. 1, for instructing execution of scan processing to a scan device.

FIGS. 3A to 3D are diagrams each showing an example of a screen displayed on a display section appearing in FIG. 1.

FIG. 4 is a flowchart of an edit control process performed by a scan function-extending unit appearing in FIG. 2B.

FIGS. 5A to 5C are diagrams showing an example of a variety of information used by the scan function-extending unit appearing in FIG. 2B.

FIG. 6 is a sequence diagram of a scan control process performed in the communication system shown in FIG. 1.

FIG. 7 is a flowchart of a scan instruction command generation process performed by an extension application appearing in FIG. 2B.

FIGS. 8A and 8B are a flowchart of a control process performed by the scan device appearing in FIG. 1.

FIG. 9 is a flowchart of an edit control process performed by a scan function-extending unit of a communication system according to a second embodiment.

FIG. 10 is a sequence diagram of a scan control process performed in the communication system according to the second embodiment.

FIG. 11 is a flowchart of a scan instruction command generation process performed by an extension application of the second embodiment.

FIG. 12 is a sequence diagram of a scan control process performed in a communication system according to a third embodiment.

FIG. 13 is a sequence diagram of a scan control process performed in a communication system according to a fourth embodiment.

FIG. 14 is a sequence diagram of a scan control process performed in a communication system according to a fifth embodiment.

FIG. 15 is a flowchart of a scan instruction command generation process performed by the extension application of the fifth embodiment.

### DESCRIPTION OF THE EMBODIMENTS

The present invention will now be described in detail below with reference to the accompanying drawings showing embodiments thereof. Note that the present invention as claimed in the appended claims is not limited to the embodiments described below, and not all combinations of features described in the embodiments are absolutely essential to the solution according to the invention.

First, a program, a communication system, an information processing apparatus, and a method of controlling the information processing apparatus, according to a first embodiment of the present invention, will be described.

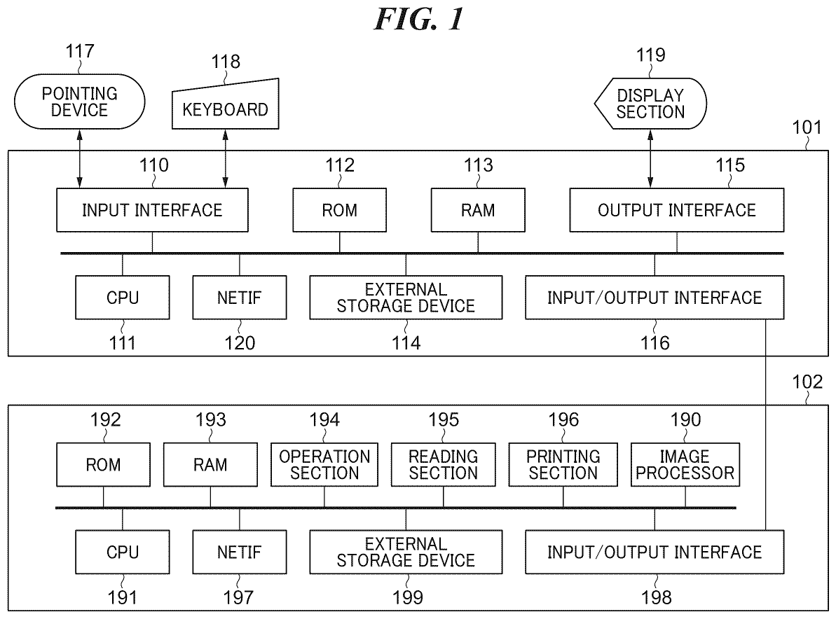

FIG. 1 is a block diagram schematically showing a hardware configuration of the communication system according to embodiments of the present invention. Referring to FIG. 1, this communication system is formed by a host computer 101 and a scan device 102.

The host computer 101 is an example of the information processing apparatus and includes an input interface 110, a central processing unit (CPU) 111, a read only memory (ROM) 112, a random access memory (RAM) 113, an external storage device 114, an output interface 115, and an input/output interface 116. To the input interface 110, input devices, such as a keyboard 118 and a pointing device 117, are connected, and to the output interface 115, a display device, such as a display section 119, is connected. The host computer 101 further includes a NET IF 120. The NET IF 120 is a network interface and performs control for performing data communication with an external apparatus via a network (not shown).

In the ROM 112, an initialization program is stored. The external storage device 114 is e.g. a hard disk drive (HDD) or a solid state drive (SSD). In the external storage device 114, an application program group, an OS, and other various data are stored. The RAM 113 is used e.g. as a work memory when a program stored in the external storage device 114 is executed. Note that in the present embodiment, the CPU 111 executes functions, described hereinafter, and processes, described hereinafter, in the host computer 101 by performing processing operations according to program codes stored in the ROM 112.

The scan device 102 is an example of an image forming apparatus and is connected to the host computer 101 via an input/output interface 198 of the scan device 102 and the input/output interface 116 of the host computer 101. The input/output interface 198 of the scan device 102 and the input/output interface 116 of the host computer 101 can be connected by a wired network or a wireless network.

The scan device 102 includes an image processor 190, a CPU 191, a ROM 192, a RAM 193, an operation section 194, a reading section 195, a printing section 196, a NET IF 197, the input/output interface 198, and an external storage device 199.

The CPU 191 performs centralized control of the scan device 102. The ROM 192 is a memory storing programs. The RAM 193 is a memory for temporarily storing a program and image data. The reading section 195 is a scanner and generates image data by reading an image of an original. The printing section 196 prints an image on a sheet based on the image data. Note that although in the present embodiment, the configuration of the scan device 102 having the printing section 196 will be described, the configuration of the scan device 102 is not limited to this configuration, but the scan device 102 is not necessarily required to include the printing section 196. The NET IF 197 is a network interface and performs control for performing data communication with an external apparatus via a network (not shown). The image processor 190 performs a variety of image editing processing operations on image data input thereto.

Note that although FIG. 1 shows the host computer 101 and the scan device 102 as separate apparatuses, these can be configured as one information processing apparatus. Note that in the present embodiment, as the scan device 102, an electrophotographic digital multifunction peripheral having a plurality of functions, such as copy, print, and FAX functions, will be described by way of example, but the scan device 102 is not limited to the digital multifunction peripheral. The scan device 102 can be an apparatus that uses another process, such as an inkjet method, or a scanner that performs only reading of an image. Further, the host computer 101 can be a desktop-type personal computer, a smartphone, or a laptop-type personal computer.

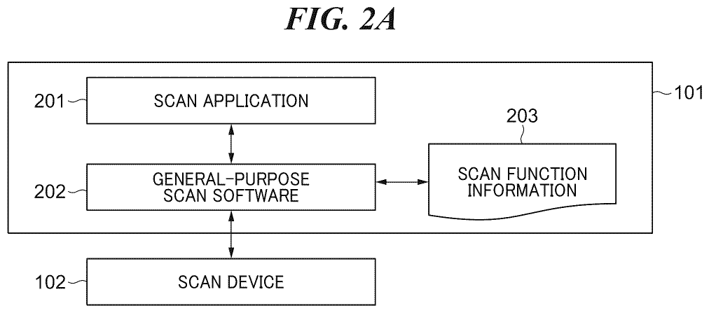

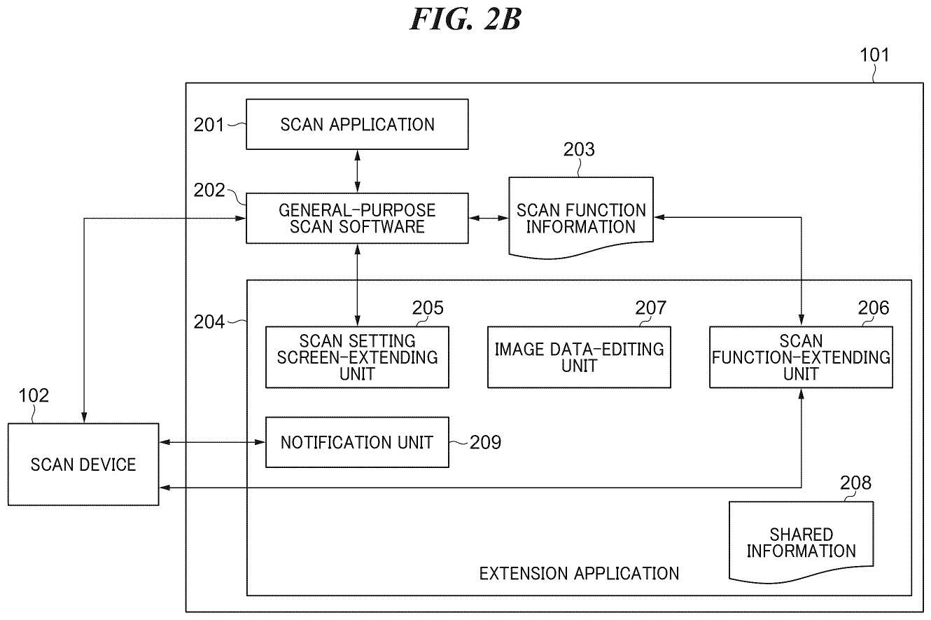

FIGS. 2A and 2B are block diagrams each schematically showing a software configuration of the host computer 101 appearing in FIG. 1, for instructing execution of scan processing to the scan device 102. Note that in the present embodiment, the description is given assuming that the host computer 101 has Windows (registered trademark) 11 of Microsoft (registered trademark) installed therein as the OS, by way of example.

FIG. 2A shows the software configuration of the host computer 101 which does not include an extension application 204, for instructing execution of scan processing to the scan device 102.

Referring to FIG. 2A, the host computer 101 includes a scan application 201 and general-purpose scan software 202 as the software for instructing execution of scan processing to the scan device 102. Processing operations performed by these software are realized by the CPU 111 that executes programs stored in the external storage device 114. Further, the host computer 101 has scan function information 203.

The scan application 201 is software for taking in contents (image data) generated by scanning an original and is e.g. a document generation application or an image editing application. Upon receipt of a scan request from a user, the scan application 201 issues a scan instruction to the OS of the host computer 101. The scan instruction includes scan setting information for instructing operations of the general-purpose scan software 202 and the scan device 102.

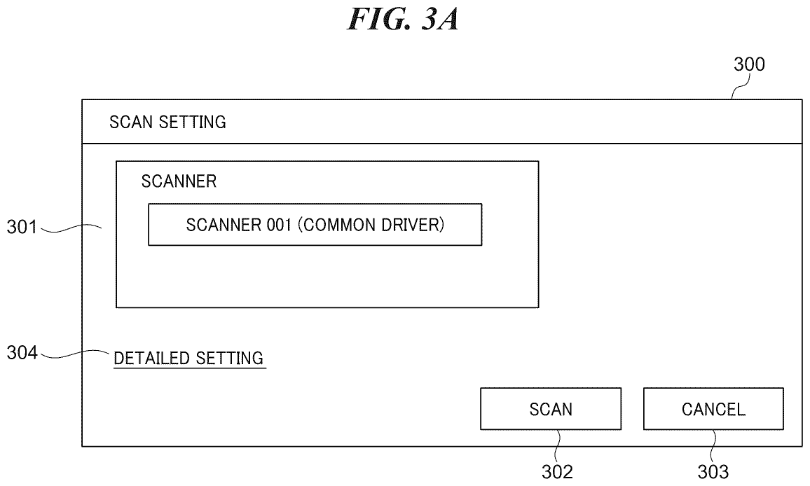

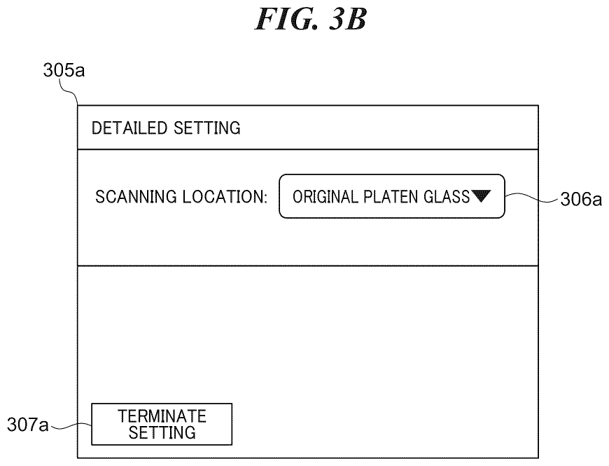

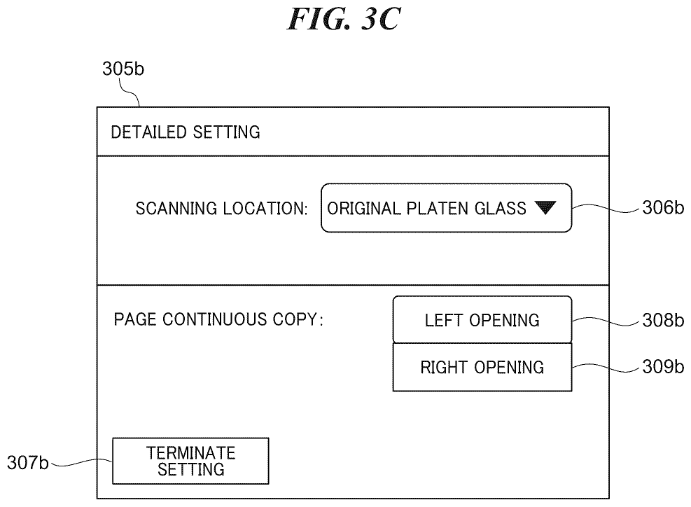

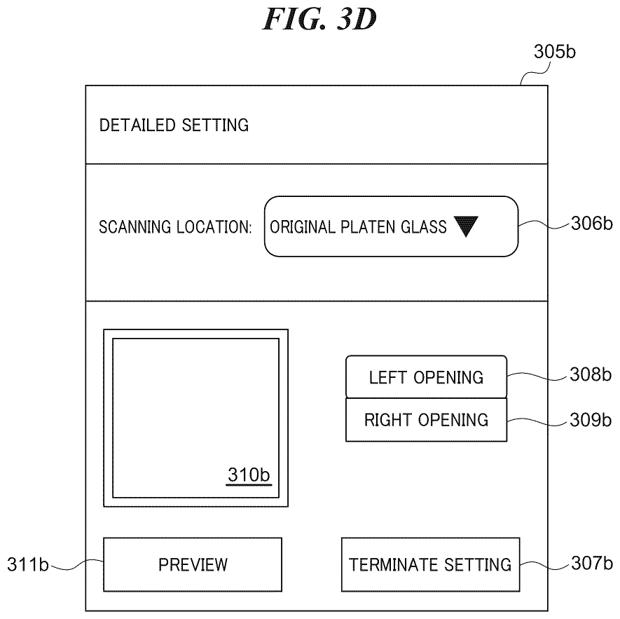

As a screen for receiving a scan request from a user, a scan setting screen provided by one of the general-purpose scan software 202, the OS of the host computer 101, and the scan application 201 is displayed on the display section 119 of the host computer 101. Further, when a detailed setting button on the scan setting screen is pressed, the general-purpose scan software 202 displays a detailed setting screen on the display section 119 of the host computer 101. Note that the configurations of the scan setting screen and the detailed setting screen will be described hereinafter with reference to FIGS. 3A to 3D. The detailed setting screen includes a setting item (hereinafter also referred to as the “control item”) indicating a scan function supported by the general-purpose scan software 202 and control items indicating settings of the scan function, according to capabilities information of the general-purpose scan software 202.

The general-purpose scan software 202 is a general-purpose program which can be commonly used for scan devices of a plurality of makers and further is a general-purpose program that generates and outputs an instruction which can be interpreted by the scan devices of the plurality of makers. The general-purpose scan software 202 is a standard class driver that controls execution of scan processing based on e.g. a standard scan protocol referred to as the Mopria. The general-purpose scan software 202 determines scan capabilities based on the scan function information 203.

The scan function information 203 is data indicating all scan functions supported by the general-purpose scan software 202 and their settings, and exclusive relationships between settings. The scan function information 203 is included in a configuration file of the general-purpose scan software 202 and is stored in the external storage device 114 as an unchangeable file. Alternatively, the scan function information 203 is dynamically generated by the general-purpose scan software 202 or the OS of the host computer 101. Specifically, the general-purpose scan software 202 or the OS of the host computer 101 acquires attribute data of the scan device 102 from the scan device 102 and generates the scan function information 203 based on the acquired attribute data. Note that the attribute data of the scan device 102 includes attribute information indicating the functions which can be designated in the scan device 102 (capabilities of the scan device 102) and settings concerning the attribute information. The attribute data of the scan device 102, which is acquired from the scan device 102, is stored in the RAM 113. Note that in a case where the scan function information 203 is dynamically generated, the generated scan function information 203 is editable.

Thus, by dynamically generating the scan function information 203, the general-purpose scan software 202 enables a user to designate a scan function which is supported by itself and is available in the scan device 102 connected to the host computer 101. That is, even when a scan device having a different function or a scan device developed by a different maker is connected to the host computer 101, a user can designate a scan function which is supported by the general-purpose scan software 202 and is at the same time available in the connected scan device. However, the general-purpose scan software 202 does not support a function unique to a maker, and hence it is impossible to allow a user to designate a scan function which is available in the scan device 102 connected to the host computer 101 and is at the same time unique to a maker. The function unique to a maker is e.g. a page continuous copy function.

The page continuous copy function is a function of outputting a read image of one original in a state divided into a plurality of image data. In the page continuous copy function, when a double-page spread of an original of e.g. a magazine or a book is read, the spread page is divided into right and left pages, whereby two image data are generated. In the page continuous copy function, it is possible to set a page order of image data to be output, specifically, which of image data of right and left pages is set to image data of a preceding page, depending on the setting of how pages are turned. For example, in a case where the original is a left-opening type, a left page of the original is the preceding page, and a right page of the original is the following page. Therefore, in a case where left-opening is set as a setting of the page continuous copy function, image data on a left page of the original is set as image data of the preceding page, and image data on a right page of the original is set as image data of the following page. On the other hand, in a case where the original is a right-opening type, the right page of the original is the preceding page, and the left page of the original is the following page. Therefore, in a case where right-opening is set as a setting of the page continuous copy function, image data of the right page of the original is set as the image data of the preceding page, and the image data of the left page of the original is set as the image data of the following page.

By using the page continuous copy function, the user can obtain separate image data with respect to the right and left pages of each double-page spread of e.g. a magazine or book. Note that in the present embodiment, a configuration will be described in which an opening method, i.e. a left-opening method or a right-opening method is set as a setting of the page continuous copy function, but the setting of the page continuous copy function is not limited to this configuration. For example, one of right and left pages, which is to be set as the preceding page, can be designated such that the left page is designated as the preceding page or the right page is designated as the preceding page. Further, although in the present embodiment, a spread page is divided into two, the division number, i.e. the number of times a spread is divided, can be a number other than two or can be variable, and for example, an original folded in three can be divided into three.

Next, the software configuration of the host computer 101 including the extension application 204, for instructing execution of scan processing to the scan device 102, will be described.

FIG. 2B is a diagram showing a software configuration of the host computer 101 including the extension application 204, for instructing scan processing to the scan device 102. Note that a component and processing, which are not particularly mentioned in FIG. 2B, are the same as those in FIG. 2A.

Referring to FIG. 2B, the host computer 101 includes not only the above-described scan application 201 and general-purpose scan software 202, but also the extension application 204 as software for instructing execution of scan processing to the scan device 102. Processing operations performed by these software are realized by the CPU 111 that executes programs stored in the external storage device 114.

The extension application 204 is software that supports the general-purpose scan software 202 and is not included (packaged) in the OS of the host computer 101 in advance. Therefore, the user is required to operate the host computer 101 to download the extension application 204 from a server via the Internet and install the downloaded extension application 204. Alternatively, the extension application 204 can be automatically installed upon connection of the scan device 102 to the host computer 101. Specifically, in a case where the scan device 102 is connected to the host computer 101, the OS of the host computer 101 acquires device identification information from the scan device 102. The OS of the host computer 101 can download the extension application 204 associated with the acquired device identification information from the server via the Internet and install the downloaded extension application 204. That is, the general-purpose scan software 202 and the extension application 204 are stored in the host computer 101 as the separate files.

Note that the general-purpose scan software 202 and the extension application 204 are sometimes updated and upgraded in its version, but this update processing is performed at different timings. That is, the timing at which the general-purpose scan software 202 is acquired by the host computer 101 and the timing at which the extension application 204 is acquired by the host computer 101 are different. Further, the trigger for acquiring the general-purpose scan software 202 by the host computer 101 and the trigger for acquiring the extension application 204 by the host computer 101 are also different. Note that in a case where the extension application 204 has been installed in the host computer 101, the OS of the host computer 101 associates the extension application 204 with the general-purpose scan software 202 and the scan device 102.

The extension application 204 includes a scan setting screen-extending unit 205, a scan function-extending unit 206, an image data-editing unit 207, and a notification unit 209. Further, the extension application 204 has shared information 208 which can be commonly accessed from these units. The shared information 208 is actually in the form of a file stored in the external storage device 114 or information stored in the RAM 113. The extension application 204 writes and reads information into and from the shared information 208 by using an application program interface (API) provided by the OS of the host computer 101.

Note that the extension application 204 can terminate its operation whenever processing executed by each unit is terminated. In this case, the OS of the host computer 101 starts the extension application 204 whenever a request for using each unit is received.

Further, while the processing is being performed by each unit, the extension application 204 can cancel this processing. In a case where the extension application 204 cancels processing, a job being processed is deleted by the OS of the host computer 101.

When the scan application 201 receives a scan request from a user, the scan application 201 issues a scan instruction to the OS of the host computer 101. Similar to the configuration shown in FIG. 2A, in the configuration shown in FIG. 2B, the scan application 201 can display the scan setting screen. In the configuration shown in FIG. 2B, a detailed setting screen provided by the extension application 204 is displayed. Specifically, the detailed setting screen provided by the scan setting screen-extending unit 205 of the extension application 204 is displayed. Further, the scan setting screen-extending unit 205 stores settings made by the user on the detailed setting screen in the shared information 208.

The image data-editing unit 207 edits image data acquired from the scan device 102. The image data-editing unit 207 acquires settings made on the detailed setting screen from the shared information 208 and performs image editing on the image data according to the settings. Note that the extension application 204 can acquire image data acquired by the general-purpose scan software 202 and perform image editing on this image data according to the settings. Further, also in the configuration shown in FIG. 2B, there is a case where a setting of the page continuous copy function is not made by a user. In this case, the general-purpose scan software 202 can output a scan instruction to the scan device 102 without using the extension application 204 as in the configuration shown in FIG. 2A.

The scan function-extending unit 206 can edit the scan function information 203 generated by the general-purpose scan software 202 or the OS of the host computer 101. With this, the scan function-extending unit 206 can add a function or functions provided by the extension application 204 to the scan function information 203. Further, the scan function-extending unit 206 can add a scan function or functions which is/are supported by the scan device 102 but is/are not supported by the general-purpose scan software 202 and add an exclusive relationship between settings of the scan function. Note that a function which is supported by the scan device 102 but is not supported by the general-purpose scan software 202 is e.g. the page continuous copy function. The OS of the host computer 101 starts the scan function-extending unit 206 when the extension application 204 is associated with the scan device 102 and the general-purpose scan software 202 for the first time. Further, the OS of the host computer 101 can start the scan function-extending unit 206 at a timing other than this, such as a timing when the OS of the host computer 101 is started.

The notification unit 209 can display a notification to a user in response to occurrence of an error in the scan device 102. For example, if a reading jam error has occurred in the scan device 102, the general-purpose scan software 202 detects occurrence of this error. The OS of the host computer 101 displays a message on the display section 119 by using a notification function, referred to as the toast notification, as a function of the OS. When the user presses this toast notification, the notification unit 209 of the extension application 204 is called by the OS of the host computer 101, and a user interface (UI) screen of the notification unit 209 is displayed. On the UI screen of the notification unit 209, for example, detailed information of the reading jam error, a jam releasing method, and so forth are displayed.

Note that the configuration of the extension application 204 is not limited to the configuration including all of the above-described functions (units) but can be a configuration having only part of the functions or a configuration including another function. Further, the extension application 204 is sometimes simply referred to as the scan software. As described above, it can be said that the extension application 204 has at least one of the following functions: The first function is the function of displaying the setting screen (the scan setting screen-extending unit 205). The second function is the function of editing image data according to the detailed setting (the image data-editing unit 207). The third function is the function of extending a function which can be designated by a user (the scan function-extending unit 206). The fourth function is the function of displaying a screen in response to occurrence of an error in the scan device 102 (the notification unit 209).

Next, an example of the scan setting screen and the detailed setting screen, displayed on the display section 119 of the host computer 101, will be described with reference to FIGS. 3A to 3D.

FIG. 3A shows an example of a scan setting screen 300 displayed by the scan application 201 appearing in FIG. 2A. As shown in FIG. 3A, the scan setting screen 300 includes a control 301, a scan button 302, a cancel button 303, and a detailed setting button 304.

The control 301 has an object for prompting a user to designate a scan device to be used for scanning an original. The scan button 302 is a button for instructing start of scanning. The cancel button 303 is a button for instructing cancellation of scanning. The detailed setting button 304 is a button for instructing display of the detailed setting screen on the display section 119. Note that in the present embodiment, the configuration of the detailed setting screen displayed on the display section 119 is different depending on whether or not the host computer 101 includes the extension application 204.

For example, on the display section 119 of the host computer 101 which does not include the extension application 204 (see e.g. FIG. 2A), a detailed setting screen 305a shown in FIG. 3B is displayed. The detailed setting screen 305a is displayed on the display section 119 by the general-purpose scan software 202 when the user presses the detailed setting button 304. The detailed setting screen 305a has a control 306a and a setting termination button 307a. With the control 306a, a scanning location can be set, and in FIG. 3B, “original platen glass” is set by way of example. The setting termination button 307a is a button for terminating setting on the detailed setting screen 305a. When the user presses the setting termination button 307a, the screen on the display section 119 returns to the scan setting screen 300.

On the other hand, on the display section 119 of the host computer 101 which includes the extension application 204 (see e.g. FIG. 2B), a detailed setting screen 305b shown in FIG. 3C is displayed. The detailed setting screen 305b is displayed on the display section 119 by the scan setting screen-extending unit 205 when the user presses the detailed setting button 304. Note that although in the present embodiment, the configuration that the scan setting screen-extending unit 205 displays the detailed setting screen 305b on the display section 119 will be described, this is not limitative. For example, the scan setting screen-extending unit 205 can be configured only to generate data to be displayed on the detailed setting screen 305b. In this case, the scan setting screen-extending unit 205 transmits the generated data for display to the scan application 201 via the general-purpose scan software 202. The scan application 201 displays the detailed setting screen 305b on the display section 119 by using the acquired data for display.

The detailed setting screen 305b has not only a control 306b having the same function as the above-mentioned control 306a and a setting termination button 307b having the same function as the above-mentioned setting termination button 307a, but also a control 308b and a list 309b. The control 308b is a button for making a setting of the page continuous copy function. In FIG. 3C, “left opening” has been selected by way of example. The list 309b is a list of settings which can be set by a user and is displayed when the user presses the control 308b. A setting “right opening” is also included in the list 309b. When the user selects one setting from the list 309b, the host computer 101 can generate a scan instruction command, described hereinafter, including the selected setting.

Here, a reason for a difference in setting items between the detailed setting screen 305a and the detailed setting screen 305b will be described.

The detailed setting screen 305a displayed on the display section 119 of the host computer 101 which does not include the extension application 204 is generated by referring to scan capabilities generated based on the scan function information 203. The scan function information 203 includes information on the scan functions supported by the general-purpose scan software 202 as described above. However, the general-purpose scan software 202 does not support the page continuous copy function, and hence the information on the page continuous copy function is not included in the scan function information 203. Therefore, the control 308b and the list 309b for performing setting concerning the page continuous copy function are not included in the detailed setting screen 305a.

On the other hand, the detailed setting screen 305b displayed on the display section 119 of the host computer 101 which includes the extension application 204 is generated by referring to scan capabilities generated based on the scan function information 203 edited by the scan function-extending unit 206. To this scan function information 203, the information on the page continuous copy function is added by the scan function-extending unit 206. With this, in the detailed setting screen 305b, the control 308b and the list 309b for performing setting concerning the page continuous copy function are included. Note that a setting item of a scan function unique to a maker, other than the page continuous copy function, can be further included in the detailed setting screen 305b.

Next, an edit control process performed by the scan function-extending unit 206 for editing the scan function information 203 will be described.

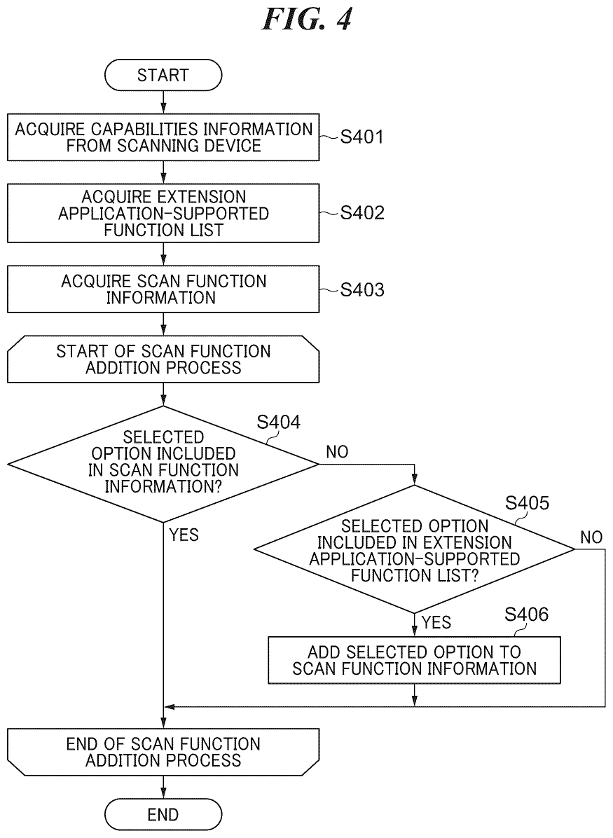

FIG. 4 is a flowchart of the edit control process performed by the scan function-extending unit 206 appearing in FIG. 2B. The edit control process in FIG. 4 is realized by the CPU 111 that executes the program of the extension application 204, which is loaded from the external storage device 114 into the RAM 113. The edit control process in FIG. 4 is executed e.g. when the extension application 204 is started.

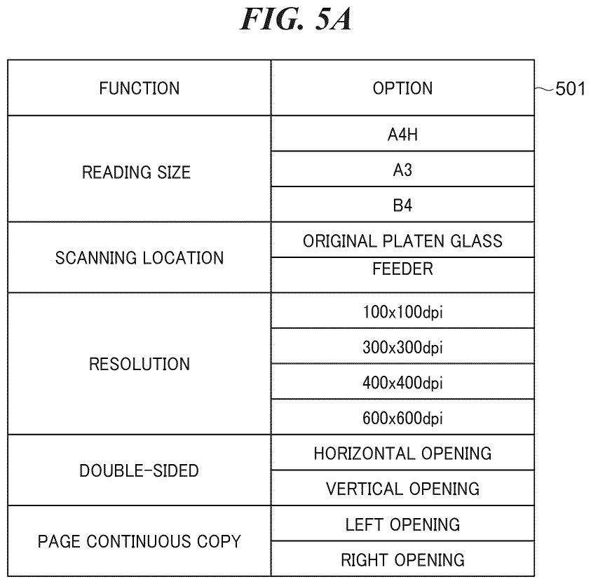

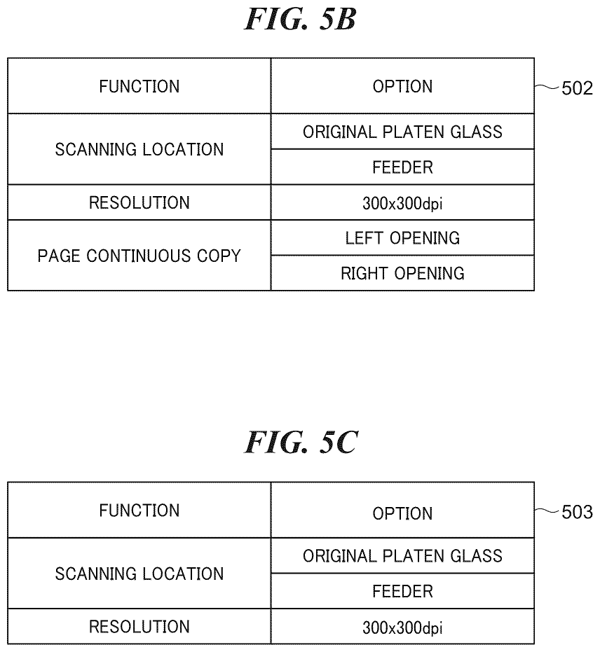

Referring to FIG. 4, first, in a step S401, the scan function-extending unit 206 acquires the capabilities information from the scan device 102 connected to the host computer 101. The capabilities information is attribute information indicating the functions which can be designated in the scan device 102 and settings concerning the attribute information. A table 501 shown in FIG. 5A indicates an example of the capabilities information acquired from the scan device 102. As shown in the table 501, the information on the functions, such as a reading size and the page continuous copy function, and options as settings which can be set to each function, can be acquired from the scan device 102.

Next, in a step S402, the scan function-extending unit 206 acquires a list of scan functions supported by the extension application 204 (hereinafter referred to as the “extension application-supported function list”). The extension application-supported function list indicates the capabilities information of the extension application 204 and is registered in the shared information 208. In the extension application-supported function list, all scan functions supported by the extension application 204 and settings of the scan functions are described. A table 502 shown in FIG. 5B is an example of the extension application-supported function list. The extension application-supported function list is sometimes updated e.g. by the update of the extension application 204.

Then, in a step S403, the scan function-extending unit 206 acquires the scan function information 203 generated by the general-purpose scan software 202 from the OS. A table 503 shown in FIG. 5C is an example of the scan function information 203 generated by the general-purpose scan software 202. The general-purpose scan software 202 generates the scan function information 203 based on the capabilities information acquired from the scan device 102 (see e.g. the table 501 shown in FIG. 5A). The scan function information 203 generated by the general-purpose scan software 202 records, out of a plurality of scan functions recorded in the capabilities information acquired from the scan device 102, only the scan functions supported by the general-purpose scan software 202. Therefore, the functions recorded in the scan function information 203 are limited. For example, although the information on the page continuous copy function is included in the capabilities information shown in FIG. 5A, the general-purpose scan software 202 does not support the page continuous copy function (see e.g. the table 503 shown in FIG. 5C). Therefore, the information on the page continuous copy function is not recorded in the scan function information 203. In the present embodiment, the scan function-extending unit 206 adds functions and options thereof to the scan function information 203, whereby the extension application 204 can compensate for lack of the functions of the general-purpose scan software 202. Further, the scan function-extending unit 206 can also delete unnecessary function and options from the scan function information 203 generated by the general-purpose scan software 202.

Then, the scan function-extending unit 206 performs a scan function addition process. Specifically, the scan function-extending unit 206 executes a step S404, a step S405, and a step S406. The scan function addition process is a process repeatedly executed for each option of the functions recorded in the capabilities information acquired from the scan device 102 in the step S401. In the present embodiment, the scan function addition process is repeatedly executed with respect to 13 items from “A4H” as an option of the reading size to “right opening” as an option of the page continuous copy function in the capabilities information shown in FIG. 5A. The scan function-extending unit 206 selects one from the options in the capabilities information acquired in the step S401.

First, in the step S404, the scan function-extending unit 206 determines whether or not the selected option is included in the scan function information 203 generated by the general-purpose scan software 202. For example, in a case where “original platen glass” as an option of the scanning location is selected from the capabilities information shown in FIG. 5A, this “original platen glass” is included in the scan function information 203 shown in FIG. 5C. In this case, it is determined in the step S404 that the selected option is included in the scan function information 203 generated by the general-purpose scan software 202. On the other hand, in a case where “A4H” as an option of the reading size is selected from the capabilities information shown in FIG. 5A, this “A4H” is not included in the scan function information 203 shown in FIG. 5C. In this case, it is determined in the step S404 that the selected option is not included in the scan function information 203 generated by the general-purpose scan software 202.

If it is determined in the step S404 that the selected option is included in the scan function information 203 generated by the general-purpose scan software 202, the scan function-extending unit 206 selects the next option, and the edit control process returns to the step S404. Note that in a case where the option on which the determination of the step S404 has been performed is the last option in the capabilities information acquired in the step S401 (e.g. “right opening” in FIG. 5A), the scan function addition process is terminated, followed by terminating the edit control process.

If it is determined in the step S404 that the selected option is not included in the scan function information 203 generated by the general-purpose scan software 202, the edit control process proceeds to the step S405.

In the step S405, the scan function-extending unit 206 determines whether or not the selected option is included in the extension application-supported function list acquired in the step S402. For example, in a case where “100×100 dpi” as an option of the resolution is selected from the capabilities information shown in FIG. 5A, this “100×100 dpi” is not included in the extension application-supported function list shown in FIG. 5B. In this case, it is determined in the step S405 that the selected option is not included in the extension application-supported function list, and the scan function-extending unit 206 selects the next option, and the edit control process returns to the step S404. Note that in a case where the option on which the determination of the step S405 has been performed is the last option in the capabilities information acquired in the step S401, the scan function addition process is terminated, followed by terminating the edit control process.

On the other hand, in a case where “left opening” as an option of the page continuous copy function is selected from the capabilities information shown in FIG. 5A, the “left opening” is included in the extension application-supported function list shown in FIG. 5B. In this case, it is determined in the step S405 that the selected option is included in the extension application-supported function list, and the edit control process proceeds to the step S406.

In the step S406, the scan function-extending unit 206 adds the selected option to the scan function information 203. Then, the scan function-extending unit 206 selects the next option, and the edit control process returns to the step S404. Note that in a case where the option added to the scan function information 203 in the step S406 is the last option in the capabilities information acquired in the step S401, the scan function addition process is terminated, followed by terminating the edit control process.

As described above, the scan function-extending unit 206 adds an option of a scan function which is not supported by the general-purpose scan software 202 but supported by the scan device 102 and the extension application 204 to the scan function information 203. The scan capabilities are generated based on the scan function information 203 edited by the above-described edit control process in FIG. 4. Further, the scan setting screen-extending unit 205 generates data for displaying the detailed setting screen based on the generated scan capabilities. This makes it possible to display the detailed setting screen 305b shown in FIG. 3C, from which the scan function(s) which is/are not supported by the general-purpose scan software 202 but supported by the scan device 102 and the extension application 204 can be set.

Next, a scan control process performed in the communication system shown in FIG. 1, from a step of receiving a scan setting instruction to a step of displaying image data generated by the scan device 102 that scans an original, will be described.

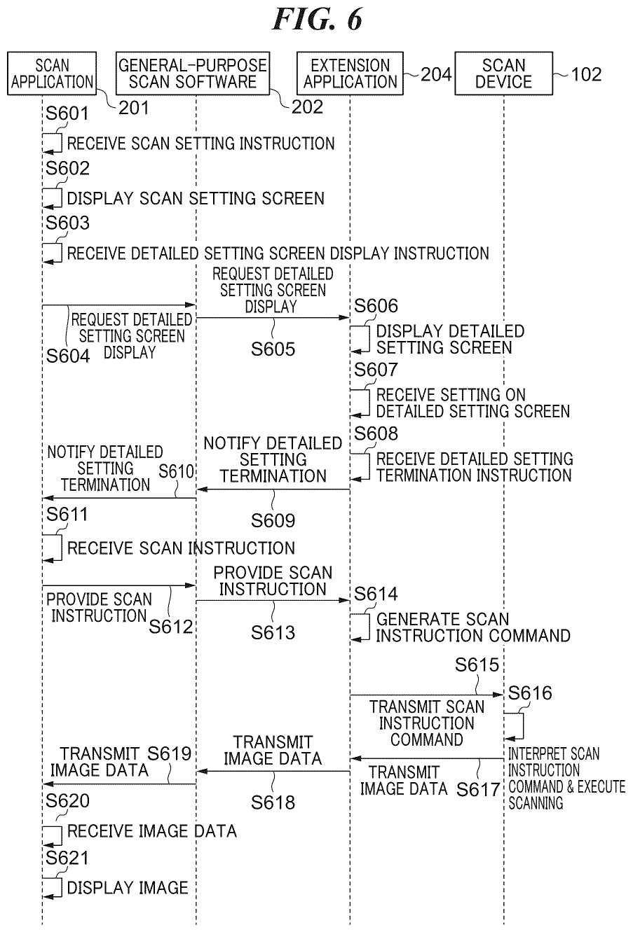

FIG. 6 is a sequence diagram of the scan control process performed in the communication system shown in FIG. 1. The processing operations performed by the host computer 101 in FIG. 6 are realized by the CPU 111 that loads the respective programs of the scan application 201, the general-purpose scan software 202, and the extension application 204 from the external storage device 114 into the RAM 113 and executes the loaded programs. Further, the processing operations performed by the scan device 102 in FIG. 6 are realized by the CPU 191 of the scan device 102, which loads the program stored in the ROM 192 or the external storage device 199 into the RAM 193 and executes the loaded program. Note that in the present embodiment, the scan control process performed by the host computer 101 configured to include the extension application 204, as shown in FIG. 2B, will be described. Further, in the scan control process in FIG. 6, it is assumed that the above-described edit control process in FIG. 4 has already been executed. By this edit control process, an option of a scan function (such as the page continuous copy function) which is not supported by the general-purpose scan software 202 but supported by the scan device 102 and the extension application 204 is added to the scan function information 203.

Referring to FIG. 6, first, in a step S601, the scan application 201 receives a scan setting instruction from a user. The scan setting instruction is an instruction for making scan settings to be used in scan processing executed by the scan device 102 connected to the host computer 101. The user can provide the scan setting instruction to the scan application 201 by operating the pointing device 117 and/or the keyboard 118.

Then, in a step S602, the scan application 201 displays the scan setting screen 300 on the display section 119 according to the received scan setting instruction.

Then, in a step S603, the scan application 201 receives an instruction for displaying the detailed setting screen. The user can provide the instruction for displaying the detailed setting screen by operating the pointing device 117 and/or the keyboard 118 to select the detailed setting button 304 on the scan setting screen 300.

Then, in a step S604, the scan application 201 transmits a request for displaying the detailed setting screen to the general-purpose scan software 202 according to the received instruction for displaying the detailed setting screen.

Then, in a step S605, the general-purpose scan software 202 transmits a request for displaying the detailed setting screen to the extension application 204 according to the received display instruction. Note that in the host computer 101 configured not to include the extension application 204 as shown in FIG. 2A, the general-purpose scan software 202 displays the detailed setting screen 305a on the display section 119.

Then, in a step S606, the scan setting screen-extending unit 205 of the extension application 204 displays the detailed setting screen 305b on the display section 119. Specifically, the scan setting screen-extending unit 205 displays the detailed setting screen 305b on the display section 119 with reference to the scan capabilities generated based on the scan function information 203 to which the option of the page continuous copy function has been added in the above-described edit control process in FIG. 4. The control 308b and the list 309b, for making a setting of the page continuous copy function, are included in the detailed setting screen 305b as described above. Note that in the present embodiment, the resolution supported by the extension application 204 is only one type of 300×300 dpi as shown in FIG. 5B, and hence there is no need of causing the user to select the option, and this setting item is not displayed on the detailed setting screen 305b. Note that this configuration is only an example, and the detailed setting screen 305b can include the setting item of the resolution in a state in which 300×300 dpi is selected.

Then, in a step S607, the scan setting screen-extending unit 205 receives settings made by the user on the detailed setting screen 305b. The detailed setting screen 305b shown in FIG. 3C shows an example in which “original platen glass” is set as the scanning location, and “left opening” is set as the setting of the page continuous copy function. The settings made on the detailed setting screen 305b are stored in the RAM 113 by the CPU 111.

Then, in a step S608, the scan setting screen-extending unit 205 receives an instruction for terminating the detailed setting from the user. The user can provide the instruction for terminating the detailed setting by operating the pointing device 117 and/or the keyboard 118 to select the setting termination button 307b. The scan setting screen-extending unit 205 having received the instruction for terminating the detailed setting writes the settings made on the detailed setting screen 305b into the scan setting information. Note that the scan setting screen-extending unit 205 can also write a setting of a setting item, which the user is not prompted to select, such as the resolution, in the scan setting information. The scan setting information is stored e.g. in the RAM 113.

Then, in a step S609, the extension application 204 notifies the general-purpose scan software 202 of termination of the detailed setting.

Then, in a step S610, the general-purpose scan software 202 notifies the scan application 201 of termination of the detailed setting.

The scan application 201 having received this notification switches the screen on the display section 119 to the scan setting screen 300. Further, in a step S611, the scan application 201 receives a scan instruction from the user. The user can provide the scan instruction by operating the pointing device 117 and/or the keyboard 118 to select the scan button 302.

Then, in a step S612, the scan application 201 provides a scan instruction to the general-purpose scan software 202.

Then, in a step S613, the general-purpose scan software 202 provides the scan instruction to the extension application 204.

Then, in a step S614, the extension application 204 generates a scan instruction command based on the scan setting information written in the step S608. In a case where a setting of an item, which the user is not prompted to select, such as the resolution, has not been written into the scan setting information, the extension application 204 can add this setting to the scan instruction command when the scan instruction command is generated in the step S614. Further, instead of adding this setting, the scan device 102 can be configured to operate with a default setting of the scan device 102.

Then, in a step S615, the extension application 204 transmits (outputs) the scan instruction command to the scan device 102.

Then, in a step S616, the scan device 102 interprets the received scan instruction command and executes scan processing. In the step S616, image processing based on the scan instruction command is performed on image data obtained by scanning an original. Note that in the present embodiment, in a case where the setting of the page continuous copy function has been made on the detailed setting screen 305b, scan processing based on the setting made by the control 308b is performed. Thus, two image data formed by the image of a double-page spread of an original, specifically, image data of the left page and image data of the right page of the original are generated. Note that in each of file names of the generated two image data, a predetermined character string is included which enables identification of image data of the preceding page from the two image data. The predetermined character string is e.g. a number corresponding to the page order determined according to the setting of the page continuous copy function. To the end of the file name of the image data of the preceding page, “001” indicating this fact is added, and to the end of the file name of the image data of the following page, “002” indicating this fact is added. With this, it is possible to identify from the file name which of the two image data is image data of the preceding page.

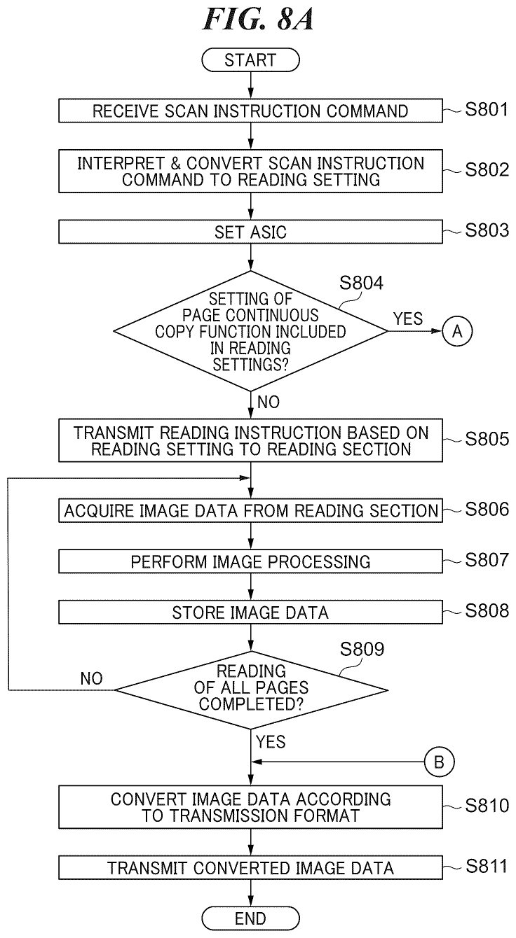

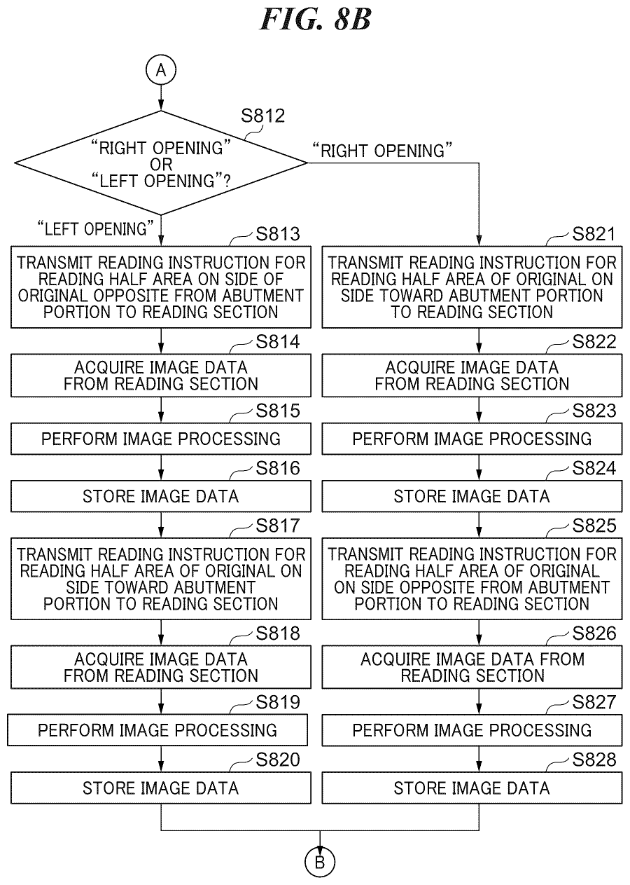

Then, in a step S617, the scan device 102 transmits the generated image data to the extension application 204. Note that the processing operations in the step S616 and the step S617, which are executed by the scan device 102, will be described hereinafter with reference to FIGS. 8A and 8B.

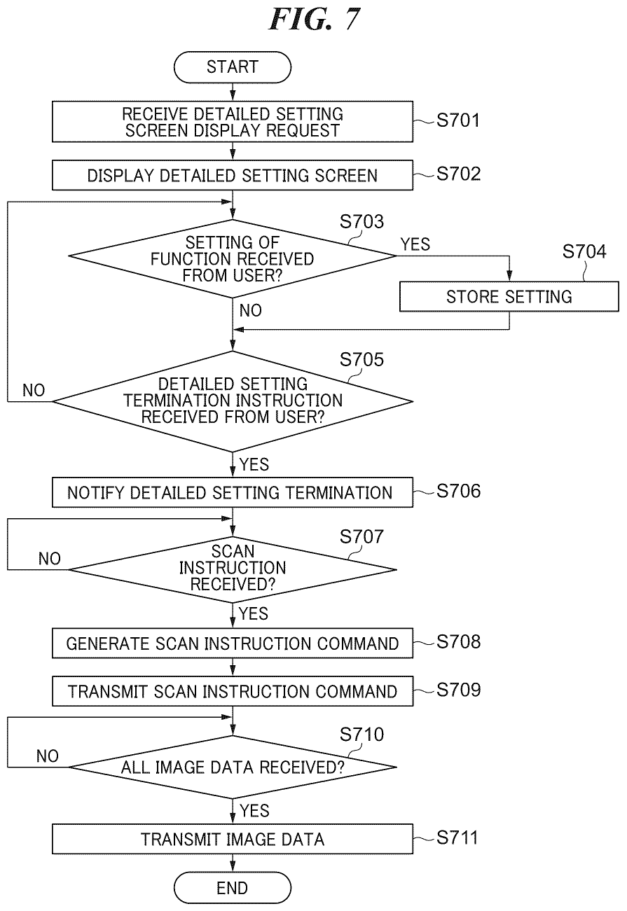

Then, in a step S618, the extension application 204 transmits the received image data to the general-purpose scan software 202. Note that the processing operations in the above-described steps S606, S607, S608, S609, S614, S615, and S618, which are executed by the extension application 204, will be described hereinafter with reference to FIG. 7.

Then, in a step S619, the general-purpose scan software 202 transmits the received image data to the scan application 201.

Then, in a step S620, the scan application 201 receives the image data. Then, in a step S621, the scan application 201 displays an image based on the received image data on the display section 119. On the display section 119, for example, the image data obtained by the scan processing based on the setting made by the control 308b (scan processing by using the page continuous copy function) is displayed. For example, the image data of the preceding page determined according to the setting of the page continuous copy function is displayed on the display section 119, and the image data of the following page is displayed on the display section 119 according to a switching instruction provided by the user. Note that all of the received image data can be displayed on the display section 119 at once such that the user is aware of the page order determined according to the setting of the page continuous copy function. When the processing in the step S621 is completed, the present process is terminated.

Note that although in the present embodiment, the scan application 201 displays the image data received from the scan device 102 on the display section 119 in the above-described step S621, this is not limitative. For example, the extension application 204 can display the image data on the display section 119. In this configuration, for example, as shown in FIG. 3D, the detailed setting screen 305b can further include a display area 310b for displaying a result of reading an original as a preview image and a control 311b for instructing the display of the preview image in the display area 310b. When the control 311b is operated in the state shown in FIG. 3D, the detailed setting screen 305b is shifted to a state in which the preview image is displayed in the display area 310b. Note that this preview image can be a low-resolution image. In the display area 310b, for example, out of the two image data output by dividing, the image data of the preceding page is displayed as the preview image, and the preview image is switched to the image data of the following page according to a switching instruction received from the user. Further, by operating the control 308b in the state in which the preview image is displayed, it is also possible to change which of the right and left pages of the original is to be set as the preceding page. With this, the preview image in the display area 310b is updated to an image according to the changed settings. The preview image at this time can be an image based on a scanned image obtained by scanning the original again or can be an image obtained by the extension application 204 that processes the scanned image which has already been obtained. Then, if the preview image in the display area 310b is an image desired by the user, the control 308b is operated. With such a configuration, the user can instruct execution of actual scanning after confirming a result of pre-scanning.

Next, a scan instruction command generation process performed by the extension application 204 will be described. The scan instruction command generation process includes the above-described processing operations in the respective steps S606, S607, S608, S609, S614, S615, and S618.

FIG. 7 is a flowchart of the scan instruction command generation process performed by the extension application 204 appearing in FIG. 2B. The scan instruction command generation process in FIG. 7 is realized by the CPU 111 that executes the program of the extension application 204, which is loaded from the external storage device 114 into the RAM 113.

Referring to FIG. 7, first, in a step S701, the extension application 204 receives a request for displaying the detailed setting screen from the general-purpose scan software 202. Then, in a step S702, the scan setting screen-extending unit 205 of the extension application 204 displays the detailed setting screen 305b on the display section 119 according to the received display request (see e.g. the above-described step S606).

Then, in a step S703, the scan setting screen-extending unit 205 determines whether or not a setting of the function has been received from the user on the detailed setting screen 305b.

If it is determined in the step S703 that a setting of the function has been received from the user (see e.g. the above-described step S607), the extension application 204 stores the setting made on the detailed setting screen 305b in the RAM 113 (S704). Then, the present process proceeds to a step S705.

If it is determined in the step S703 that the setting of the function has not been received from the user, the process directly proceeds to the step S705.

In the step S705, the scan setting screen-extending unit 205 determines whether or not an instruction for terminating the detailed setting has been received from the user.

If it is determined in the step S705 that an instruction for terminating the detailed setting has not been received from the user, the process returns to the step S703. If it is determined in the step S705 that an instruction for terminating the detailed setting has been received from the user (see e.g. the above-described step S608), the process proceeds to a step S706. Note that if it is determined that both of the answers to the questions of the step S703 and S705 are affirmative (YES), the scan setting screen-extending unit 205 writes the setting(s) made on the detailed setting screen 305b in the scan setting information. Then, the present process proceeds to the step S706.

In the step S706, the extension application 204 notifies the general-purpose scan software 202 of termination of the detailed setting (see e.g. the above-described step S609).

Then, in a step S707, the extension application 204 determines whether or not a scan instruction has been received from the general-purpose scan software 202. The extension application 204 waits until a scan instruction is received, and when a scan instruction is received (YES in S707), in a step S708, the extension application 204 generates a scan instruction command based on the scan setting information written in the step S705 (see e.g. the above-described step S614). As the method of generating a scan instruction command, a method of extending a function to a command based on the standard protocol can be used. As the method of extending a function to a command based on the standard protocol, for example, a method of recording e.g. a setting of the page continuous copy function in an extended area of the command as a dedicated command, and a method of adding a command portion of a maker-specific standard to the end of the command can be used. Further, as the method of generating a scan instruction command, a method of converting a command based on the standard protocol to a specific command system by the extension application 204 can be used. Further, in a case where an instruction is provided from the extension application 204, the instruction and communication can be performed according to a protocol specific to a maker regardless of the standard protocol.

Then, in a step S709, the extension application 204 transmits (outputs) the scan instruction command to the scan device 102 (see e.g. the above-described step S615).

Then, in a step S710, the extension application 204 determines whether or not all of the image data have been received from the scan device 102. The extension application 204 waits until all of the image data are received, and when all of the image data have been received (YES in S710), in a step S711, the extension application 204 transmits the received image data to the general-purpose scan software 202 (see e.g. the above-described step S618). After that, the present process is terminated.

Next, a control process performed by the scan device 102 will be described. The control process includes the above-described processing operations in the respective steps S616 and S617.

FIGS. 8A and 8B are a flowchart of the control process performed by the scan device 102 appearing in FIG. 1. The control process in FIGS. 8A and 8B is realized by the CPU 191 that executes the program stored in the RAM 192.

Referring to FIG. 8A, first, in a step S801, the CPU 191 receives the scan instruction command sent from the extension application 204.

Then, in a step S802, the CPU 191 analyzes the scan instruction command acquired in the step S801 and converts the scan instruction command to reading settings used by the scan device 102 for scan processing. In the present embodiment, let it be assumed that the CPU 191 converts the scan instruction command to the reading settings in which the scanning location is set to “original platen glass”, the setting of the page continuous copy function is set to “left opening”, and the resolution is set to “300×300 dpi”. Then, in a step S803, the CPU 191 determines an application specific integrated circuit (ASIC) of the image processor 190, which is to be used to execute scan processing based on the reading settings converted in the step S802. Then, in a step S804, the CPU 191 determines whether or not a setting of the page continuous copy function is included in the reading settings.

If it is determined in the step S804 that a setting of the page continuous copy function is not included in the reading settings, the present process proceeds to a step S805. In the step S805, the CPU 191 transmits a reading instruction based on the reading settings to the reading section 195. The reading section 195 performs a reading operation according to this reading instruction.

Then, in a step S806, the CPU 191 acquires image data from the reading section 195. Then, in a step S807, the CPU 191 controls the image processor 190 to perform image processing on the acquired image data. In the step S807, for example, image processing for converting the resolution to 300×300 dpi is performed on the acquired image data. Note that in a case where the reading section 195 is capable of performing reading at the resolution of 300×300 dpi and has acquired the image data at the resolution of 300×300 dpi, the process can be configured to omit execution of the image processing for converting the resolution to 300×300 dpi in the step S807.

Then, in a step S808, the CPU 191 stores the image data in the external storage device 199. Then, in a step S809, the CPU 191 determines whether or not reading of all pages has been completed.

If it is determined in the step S809 that one of the pages has not been read, the process returns to the step S806.

If it is determined in the step S809 that reading of all pages has been completed, the process proceeds to a step S810. In the step S810, the CPU 191 controls the image processor 190 to convert the image data stored in the step S808 to a designated transmission format. In the present embodiment, the transmission format is not included in the scan instruction command acquired in the step S801, and the image data is converted to the JPEG format as the default setting of the scan device 102 in the step S810, but the transmission format to be converted is not limited to this. The transmission format to which the image data is to be converted can be a format other than the JPEG format insofar as it is a format supported by the host computer 101. Then, in a step S811, the CPU 191 controls the NET IF 197 to transmit the image data converted in the step S810 to the extension application 204. After that, the present process is terminated.

If it is determined in the step S804 that a setting of the page continuous copy function is included in the reading settings, the present process proceeds to a step S812 in FIG. 8B. In the step S812, the CPU 191 determines whether the setting of the page continuous copy function is “left opening” or “right opening”.

If it is determined in the step S812 that the setting of the page continuous copy function is left opening, the present process proceeds to a step S813. In the step S813, the CPU 191 transmits a reading instruction according to the reading settings to the reading section 195. Here, on the original platen glass, the original is arranged such that the front surface of the original is opposed to the glass surface, and a right edge portion (hereinafter referred to as the “abutment portion”) of the front surface of the original is set at a reference position of the original platen glass. In the original of the left-opening type, a page on the left side is the preceding page (even-numbered page), and a page on the right side is the following page (odd-numbered page), and hence the abutment portion of the original of the left-opening type is the right end portion of the following page (odd-numbered page). In the step S813, the CPU 191 transmits the reading instruction for reading the area of the preceding page, i.e. the half area on a side of the original opposite from the abutment portion to the reading section 195. For example, in a case where an A3-sized original is read, the reading section 195 having received the reading instruction reads an area corresponding to the A4 size by making room for an area corresponding to the A4 size starting from the abutment portion.

Then, in a step S814, the CPU 191 acquires the image data from the reading section 195. Then, in a step S815, the CPU 191 controls the image processor 190 to perform image processing on the acquired image data. Also in the step S815, for example, the image processing for converting the resolution to 300×300 dpi is performed on the acquired image data. Then, in a step S816, the CPU 191 stores the image data in the external storage device 199. Then, in a step S817, the CPU 191 transmits a reading instruction according to the reading settings to the reading section 195. Specifically, as the second reading instruction, the CPU 191 transmits the reading instruction for reading the area of the following page, i.e. the half area on the side of the original toward the abutment portion, to the reading section 195. For example, in a case where the A3-sized original is read, the reading section 195 having received the reading instruction reads the area corresponding to the A4 size starting from the abutment portion. Then, in a step S818, the CPU 191 acquires the image data from the reading section 195. Then, in a step S819, the CPU 191 controls the image processor 190 to perform image processing on the acquired image data. Also in the step S819, for example, the image processing for converting the resolution to 300×300 dpi is performed on the acquired image data. Then, in a step S820, the CPU 191 stores the image data in the external storage device 199. Then, the present process proceeds to the step S810.

On the other hand, if it is determined in the step S812 that the setting of the page continuous copy function is right opening, the present process proceeds to a step S821. In the step S821, the CPU 191 transmits a reading instruction according to the reading settings to the reading section 195. Here, in the original of the right-opening type, a page on the right side is the preceding page (even-numbered page), and a page on the left side is the following page (odd-numbered page), and hence the abutment portion of the original of the right-opening type is the right end portion of the preceding page (even-numbered page). In the step S821, the CPU 191 transmits the reading instruction for reading the area of the preceding page, i.e. the half area of the original on the side toward the abutment portion, to the reading section 195. Then, in a step S822, the CPU 191 acquires image data from the reading section 195. Then, in a step S823, the CPU 191 controls the image processor 190 to perform image processing on the acquired image data. In the step S823 as well, for example, the image processing for converting the resolution to 300×300 dpi is performed on the acquired image data. Then, in a step S824, the CPU 191 stores the image data in the external storage device 199.

Then, in a step S825, the CPU 191 transmits a reading instruction according to the reading settings to the reading section 195. Specifically, as the second reading instruction, the CPU 191 transmits the reading instruction for reading the area of the following page, i.e. the half area of the original on the side opposite from the abutment portion, to the reading section 195. Then, in a step S826, the CPU 191 acquires the image data from the reading section 195. Then, in a step S827, the CPU 191 controls the image processor 190 to perform image processing on the acquired image data. In the step S827 as well, for example, the image processing for converting the resolution to 300×300 dpi is performed on the acquired image data. Then, in a step S828, the CPU 191 stores the image data in the external storage device 199. Then, the present process proceeds to the step S810.

According to the above-described embodiment, the extension application 204 displays the detailed setting screen 305b for receiving the setting of the page continuous copy function on the display section 119. Further, the extension application 204 outputs the scan instruction command for causing the scan device 102 to execute scan processing using the page continuous copy function based on the settings made on the detailed setting screen 305b. With this, the user is enabled to use the page continuous copy function.

Further, in the above-described embodiment, on the detailed setting screen 305b, a setting for determining the page order of the divided image data is made by the user. With this, it is possible to reflect user's intention with respect to the page order of the divided image data.

Further, in the above-described embodiment, in the scan processing using the page continuous copy function, reading of one original is performed a plurality of times. With this, it is possible to cause the scan device 102 to output separate image data for the right and left pages of each double-page spread.

Further, in the above-described embodiment, the extension application 204 generates a scan instruction command for causing the scan device 102 to execute scan processing using the page continuous copy function based on the settings made on the detailed setting screen 305b. With this, it is possible to cause the scan device 102 to execute scan processing using the page continuous copy function based on the settings made on the detailed setting screen 305b.

Further, in the above-described embodiment, the scan instruction command is a command generated by extending the function to the command based on the standard protocol. With this, it is possible to cause the scan device 102 to execute scan processing using the page continuous copy function based on the settings made on the detailed setting screen 305b, by using the standard protocol.

Further, in the above-described embodiment, the scan instruction command is generated by converting the command based on the standard protocol to a command system specific to the extension application 204. With this, it is possible to reflect the setting of a scan function which is not supported by the standard protocol, on the scan instruction command.

Further, in the above-described embodiment, setting items displayed on the detailed setting screen 305b are determined by using the capabilities information of the scan device 102 designated by the user. With this, it is possible to cause the setting item of a scan function which is not supported by the general-purpose scan software 202 but supported by the scan device 102 to be included in the detailed setting screen 305b.

Note that although in the above-described embodiment, the description has been given of the configuration that the scan device 102 performs reading of one original twice in the page continuous copy function, this is not limitative. For example, the reading of one original can be performed only once, and the image processor 190 can perform image processing on the image data obtained by this reading and divide the image data into image data of the preceding page and image data of the following page.

Further, although in the above-described embodiment, the detailed setting screen 305b is displayed on the display section 119 of the host computer 101 including the extension application 204 (see e.g. FIG. 2B), the present invention is not limited to this configuration. For example, the general-purpose scan software 202 having received the detailed setting screen display request in the step S604 can display the detailed setting screen 305a on the display section 119. After a setting operation on this detailed setting screen 305a is terminated, the general-purpose scan software 202 transmits an additional detailed setting screen display request to the extension application 204. According to this display request, the extension application 204 displays, for example, a detailed setting screen (not shown) formed by the setting termination button 307b, the control 308b, and the list 309b without the control 306b, on the display section 119. With this configuration, the user is also enabled to use the page continuous copy function.

Further, although in the above-described embodiment, the general-purpose scan software 202 provides a scan instruction to the extension application 204 in the step S613, this is not limitative. For example, the scan application 201 can directly provide a scan instruction to the extension application 204. Further, by disposing a control for instructing scan on the detailed setting screen 305b, the user can directly provide an instruction to the extension application 204.

Further, although in the above-described embodiment, the extension application 204 transfers the image data received from the scan device 102 to the scan application 201 via the general-purpose scan software 202, this is not limitative. For example, the extension application 204 can directly transfer the image data to the scan application 201 without using the general-purpose scan software 202. Further, the image data can be transferred from the scan device 102 to the scan application 201. Further, the image data acquired from the scan device 102 can be stored in the external storage device 114, and only information of a file path indicating the storage location can be transferred.

Further, although in the above-described embodiment, transfer of image data is started after it is determined in the step S710 that all of the image data items have been received, this is not limitative. For example, the transmitted image data can be transferred on an as-needed basis.

Further, although in the above-described embodiment, the scan device 102 transmits the generated image data to the host computer 101, this is not limitative. For example, the scan device 102 cam transmit the generated image data to a designated transmission destination by FAX or email. The transmission destination can be stored in the scan device 102, and the processing can be completed by the scan device 102 after scanning is instructed. Further, a transmission destination stored in an address book of e.g. a personal computer or a smartphone can be acquired. Further, a destination input screen/field can be displayed to prompt a user to set the transmission destination.

Further, in the above-described embodiment, the detailed setting screen 305b can further include a setting item for setting the data format of image data to be output. This setting item is for setting the data format of image data, such as JPEG or PDF, and a setting of the setting item is also included in the scan instruction command generated in the step S614. With this, it is possible to prompt a user to designate the data format of image data to be output.

Further, although in the above-described embodiment, the scan device 102 transmits two image data generated by the scan processing in the step S616 to the host computer 101, this is not limitative. For example, one image file including the two image data generated by the scan processing in the step S616 can be transmitted to the host computer 101. For example, in a case where the user sets the data format of the image to JPEG on the detailed setting screen 305b, the scan device 102 performs the scan processing in the step S616 according to a scan instruction command also based on this setting. The scan device 102 transmits the two image data of the JPEG format, generated in this scan processing, to the host computer 101. On the other hand, in a case where the user sets the data format of the image to PDF on the detailed setting screen 305b, the scan device 102 performs the scan processing in the step S616 according to a scan instruction command also based on this setting. The scan device 102 transmits one image file of the PDF format, including the two image data generated in this scan processing, to the host computer 101. In the file name of this image file, the above-mentioned predetermined character string which enables identification of the image data of the preceding page is not included, but for example, data generation date and time are included in e.g. the end of the file name. With this configuration, in the scan processing for scanning a double-page spread of an original, it is possible to provide one image file including the image data of the right page and the image data of the left page, to the user.

Note that the page continuous copy function is used when scanning a magazine or a book, and the original platen glass is generally used therefor. Therefore, in a case where not “original platen glass” but “feeder” is selected in designation of the scanning location, the control can be performed to disable selection of the control 308b and the list 309b, for making a setting concerning the page continuous copy function. Thus, in a case where a setting of another function mismatching the page continuous copy function is made, the control is performed to inhibit making a setting of the page continuous copy function. This makes it possible to prevent generation of a scan instruction command based on information on the mismatched settings.

Next, a program, a communication system, an information processing apparatus, and a method of controlling the information processing apparatus, according to a second embodiment, will be described. The second embodiment has basically the same configuration and effects as the above-described first embodiment but is different from the first embodiment in that the scan device 102 does not support the page continuous copy function. Therefore, description of the redundant configuration and effects is omitted, and the following description will be given of different configuration points and effects.

Here, in the above-described first embodiment, the description has been given of the configuration that the extension application 204 generates a scan instruction command including a setting of the page continuous copy function, and the scan device 102 executes scan processing according to this scan instruction command. However, there is a case where, in the first place, the scan device 102 does not support the page continuous copy function. In this case, the user cannot use the page continuous copy function.

To cope with this, in the second embodiment, the extension application 204 determines whether or not the scan device 102 supports the page continuous copy function based on the capabilities information of the scan device 102. In a case where the scan device 102 supports the page continuous copy function, the extension application 204 generates a scan instruction command including a setting of the page continuous copy function, which is designated by the user, and transmits this scan instruction command to the scan device 102. On the other hand, in a case where the scan device 102 does not support the page continuous copy function, the extension application 204 generates a scan instruction command which does not include the setting of the page continuous copy function and transmits this scan instruction command to the scan device 102. After that, the extension application 204 acquires one image data generated by the scan device 102 according to this scan instruction command and divides this image data according to the setting of the page continuous copy function, which is designated by the user. With this, the user is enabled to use the page continuous copy function even when the scan device 102 does not support the page continuous copy function.

In the following description, differences from the above-described first embodiment will be described.

In the second embodiment, it is assumed that the scan device 102 is a scan device that does not support the page continuous copy function. In a case where the information on the page continuous copy function is not included in the capabilities information acquired from the scan device 102, the scan function-extending unit 206 of the extension application 204 performs a different process from the above-described process in the first embodiment. Specifically, in a case where the information on the page continuous copy function is not included in the acquired capabilities information, and the extension application 204 has a unit for dividing image data, the scan function-extending unit 206 adds the information on the page continuous copy function to the scan function information 203. The image data-editing unit 207 performs a process for dividing the image and determining the order of the divided data on the image data acquired from the scan device 102 based on the setting of the page continuous copy function, which is made by the user. Details of the processing will be described hereinafter.

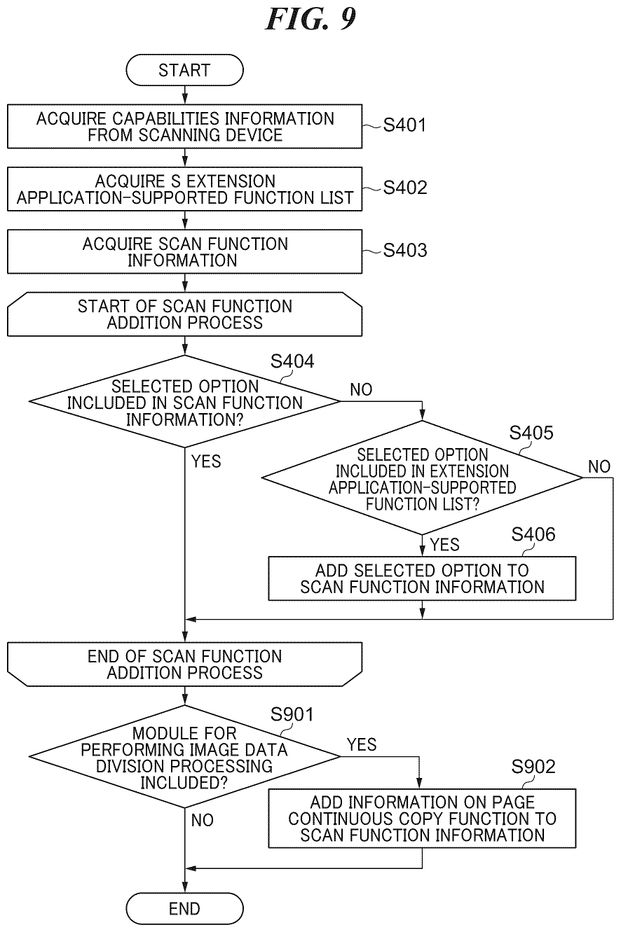

FIG. 9 is a flowchart of an edit control process performed by the scan function-extending unit 206 of the second embodiment. Note that the edit control process in FIG. 9 is similar to the above-described edit control process in FIG. 4, and the following description will be particularly given of different points from the above-described edit control process in FIG. 4. Similar to the above-described edit control process in FIG. 4, the edit control process in FIG. 9 is also realized by the CPU 111 that executes a program of the extension application 204, which is loaded from the external storage device 114 into the RAM 113. Similar to the above-described edit control process in FIG. 4, the edit control process in FIG. 9 is also executed e.g. when the extension application 204 is started.

Referring to FIG. 9, first, the above-described steps S401 to S403 are executed, and the scan function addition process (S404 to S406) are executed. Here, since the scan device 102 does not support the page continuous copy function, in the scan function addition process (S404 to S406), the information on the page continuous copy function is not added to the scan function information 203.

Then, in a step S901, the scan function-extending unit 206 determines whether or not the extension application 204 has a module for performing image data division processing. The module for performing image data division processing is e.g. the image data-editing unit 207.

If it is determined in the step S901 that the extension application 204 has the module for performing image data division processing, the scan function-extending unit 206 adds the information on the page continuous copy function to the scan function information 203 (S902). After that, the present process is terminated.

If it is determined in the step S901 that the extension application 204 does not have the module for performing image data division processing, the present process is terminated.

Thus, the scan function-extending unit 206, first, adds a function/option which is not supported by the general-purpose scan software 202 but supported by the scan device 102 and the extension application 204 to the scan function information 203. Further, in a case where the extension application 204 has the module for performing image data division processing, the scan function-extending unit 206 adds the information on the page continuous copy function to the scan function information 203. By using this scan function information 203, the detailed setting screen 305b is displayed on the display section 119 based on the scan capabilities generated by using this scan function information 203. Thus, in the second embodiment, the setting items displayed on the detailed setting screen 305b are determined by using the extension application-supported function list (the capabilities information of the extension application 204). With this, even when the scan device 102 does not support the page continuous copy function, it is possible to receive the setting of the page continuous copy function from the user.

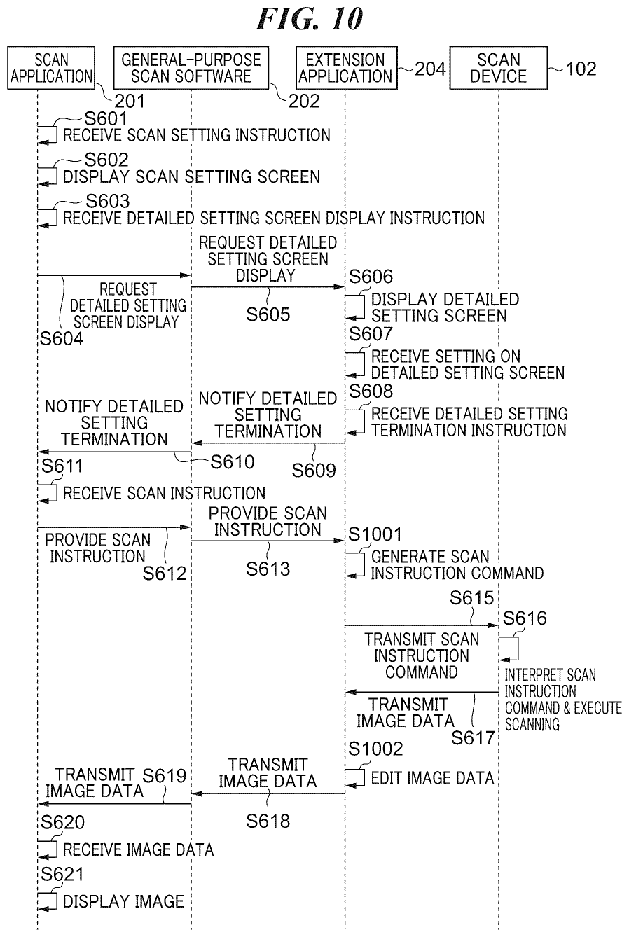

FIG. 10 is a sequence diagram of a scan control process performed in the communication system according to the second embodiment. Note that the scan control process in FIG. 10 is similar to the above-described scan control process in FIG. 6, and the following description will be given of different points from the above-described scan control process in FIG. 6. The processing operations performed by the host computer 101 in FIG. 10 are realized by the CPU 111 that loads the respective programs of the scan application 201, the general-purpose scan software 202, and the extension application 204 from the external storage device 114 into the RAM 113 and executes the loaded programs. Further, the processing operations performed by the scan device 102 in FIG. 10 are realized by the CPU 191 of the scan device 102, which loads the program stored in the ROM 192 or the external storage device 199 into the RAM 193 and executes the loaded program. Note that in the present embodiment, as described hereinabove with reference to FIG. 2B, the scan control process performed by the host computer 101 configured to include the extension application 204 will be described. Further, note that in the scan control process in FIG. 10, it is assumed that the above-described edit control process in FIG. 9 has already been executed. By this edit control process, an option of the page continuous copy function which is not supported by the general-purpose scan software 202 and the scan device 102 but supported by the extension application 204 is added to the scan function information 203.

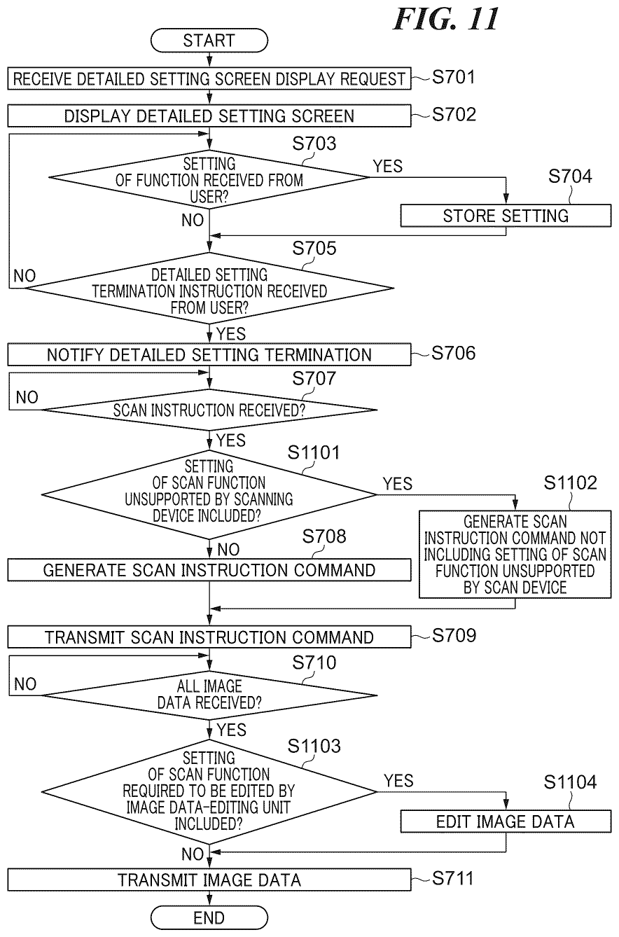

Referring to FIG. 10, first, the above-described steps S601 to S613 are executed. Then, in a step S1001, the extension application 204 generates a reading instruction command. Details of generation of the reading instruction command will be described with reference to a flowchart in FIG. 11. Then, the above-described steps S615 to S617 are executed.

Then, in a step S1002, the extension application 204 causes the image data-editing unit 207 to edit the image data received from the scan device 102. Note that details of editing of the image data received from the scan device 102 will be described with reference to the flowchart in FIG. 11. Then, the above-described steps S618 to S621 are executed, followed by terminating the present process.

Next, the scan instruction command generation process executed by the extension application 204 of the second embodiment will be described. This scan instruction command generation process includes the above-described processing operations in the respective steps S606, S607, S608, S609, S1001, S615, S1002, and S618.

FIG. 11 is a flowchart of the scan instruction command generation process performed by the extension application 204 of the second embodiment. Note that the scan instruction command generation process in FIG. 11 is similar to the above-described scan instruction command generation process in FIG. 7, and the following description will be given of different points from the above-described scan instruction command generation process in FIG. 7. Note that, similar to the above-described scan instruction command generation process in FIG. 7, the scan instruction command generation process in FIG. 11 is also realized by the CPU 111 that executes a program of the extension application 204 loaded from the external storage device 114 into the RAM 113.

Referring to FIG. 11, first, the step S701 to the step S707 are executed. When a scan instruction has been received (YES in S707), the extension application 204 acquires the capabilities information of the scan device 102 from the shared information 208. Note that if the capabilities information of the scan device 102 does not exist, the scan function-extending unit 206 of the extension application 204 can request the capabilities information from the scan device 102 and store the acquired capabilities information in the shared information 208.

Then, in a step S1101, the extension application 204 determines whether or not a setting of a scan function which is not supported by the scan device 102 is included in the scan setting information, based on the acquired capabilities information.

If it is determined in the step S1101 that a setting of a scan function which is not supported by the scan device 102 is not included in the scan setting information, the present process proceeds to the step S708 and then proceeds to the step S709.

If it is determined in the step S1101 that a setting of a scan function which is not supported by the scan device 102 is included in the scan setting information, the present process proceeds to a step S1102. In the step S1102, the extension application 204 generates a scan instruction command which does not include the setting of the scan function which is not supported by the scan device 102. In the present embodiment, the scan instruction command generated in the step S1102 does not include the setting of the page continuous copy function which is not supported by the scan device 102. Then, the present process proceeds to the S709, wherein the generated scan instruction command is transmitted to the scan device 102. Then, the present process proceeds to the step S710. When all of the image data have been received from the scan device 102 (YES in S710), the present process proceeds to a step S1103.

In the step S1103, the extension application 204 determines whether or not a setting of a scan function requiring editing by the image data-editing unit 207 is included in the scan setting information. The setting of the scan function requiring editing by the image data-editing unit 207 is e.g. a setting of the page continuous copy function.

If it is determined in the step S1103 that a setting of a scan function requiring editing by the image data-editing unit 207 is not included in the scan setting information, the present process proceeds to the step S711. In the step S711, the image data received from the scan device 102 is transmitted to the general-purpose scan software 202 without being edited. After that, the present process is terminated.

If it is determined in the step S1103 that a setting of a scan function requiring editing by the image data-editing unit 207 is included in the scan setting information, the present process proceeds to a step S1104.

In the step S1104, the extension application 204 causes the image data-editing unit 207 to edit the image data received from the scan device 102 based on the setting of the page continuous copy function, which has been made in the step S703. In the present embodiment, the image data-editing unit 207 divides the image data received from the scan device 102 into two image data, specifically, the image data of the left page and the image data of the right page. Further, in a case where the setting of the page continuous copy function is left opening, the image data-editing unit 207 adds file information indicating that the image data of the left page is the image data of the preceding page and image data of the right page is image data of the following page. On the other hand, in a case where the setting of the page continuous copy function is right opening, the image data-editing unit 207 adds file information indicating that the image data of the right page is image data of the preceding page and the image data of the left page is image data of the following page. Then, the present process proceeds to the step S711, wherein the image data divided in the step S1104 are sent to the general-purpose scan software 202. After that, the present process is terminated.

In the above-described second embodiment, in a case where it is determined that the scan device 102 does not support the page continuous copy function, the scan instruction command which does not include a setting of the page continuous copy function, which has been made on the detailed setting screen 305b, is transmitted to the scan device 102. Further, the editing process for dividing one image data generated by the scan processing executed by the scan device 102 according to this scan instruction command into a plurality of image data is performed. With this, even when the scan device 102 does not support the page continuous copy function, the user is enabled to use the page continuous copy function.

Note that although in the present embodiment, a scan instruction command which does not include a setting of the page continuous copy function which is not supported by the scan device 102 is transmitted to the scan device 102, this is not limitative. Even when the scan device 102 acquires a scan instruction command including a setting of a scan function which is not supported by itself, the scan device 102 cannot interpret the setting of this scan function, and this scan function is not used in the scan processing. That is, even when the scan device 102 acquires a scan instruction command including a setting of this scan function, the scan device 102 executes scan processing equivalent to the scan processing based on the scan instruction command which does not include the setting of the scan function. Therefore, the scan instruction command including the setting of the page continuous copy function which is not supported by the scan device 102 can be transmitted to the scan device 102.

Next, a program, a communication system, an information processing apparatus, and a method of controlling the information processing apparatus, according to a third embodiment, will be described. The third embodiment has basically the same configuration and effects as the above-described first embodiment but is different from the first embodiment in that the extension application 204 edits a scan instruction command generated by the general-purpose scan software 202. Therefore, description of the redundant configuration and effects is omitted, and the following description will be given of different configuration points and effects.

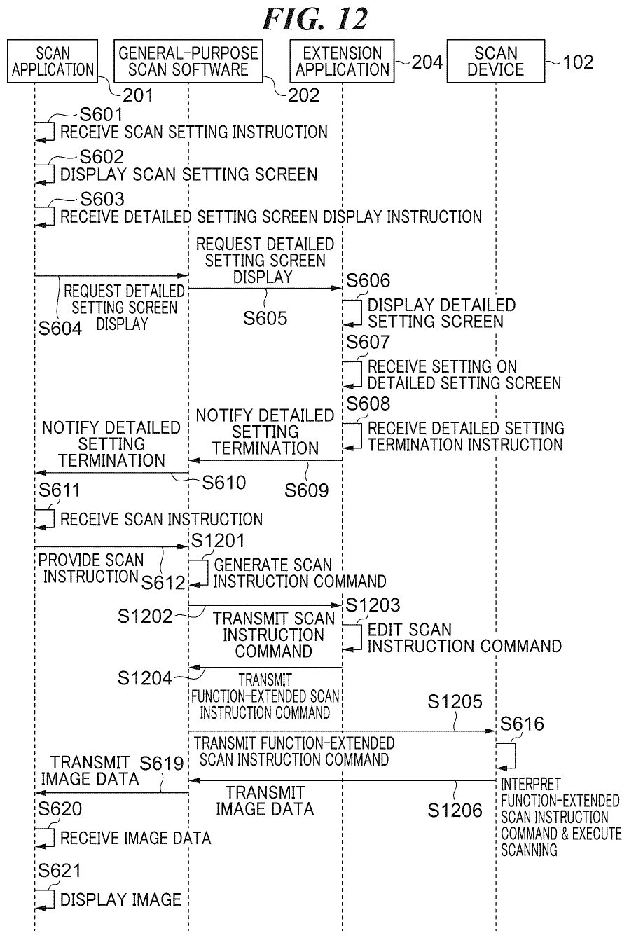

FIG. 12 is a sequence diagram of a scan control process performed in the communication system according to the third embodiment. Note that the scan control process in FIG. 12 is similar to the above-described scan control process in FIG. 6, and the following description will be particularly given of different points from the above-described scan control process in FIG. 6. The processing operations performed by the host computer 101 in FIG. 12 are realized by the CPU 111 that loads the respective programs of the scan application 201, the general-purpose scan software 202, and the extension application 204 from the external storage device 114 into the RAM 113 and executes the loaded programs. Further, the processing operations performed by the scan device 102 in FIG. 12 are realized by the CPU 191 of the scan device 102, which loads the program stored in the ROM 192 or the external storage device 199 into the RAM 193 and executes the loaded program. Note that also in the scan control process in FIG. 12, as described hereinabove with reference to FIG. 2B, the scan control process performed by the host computer 101 configured to include the extension application 204, will be described. Further, note that also in the scan control process in FIG. 12, it is assumed that the above-described edit control process in FIG. 4 has already been executed. By this edit control process, an option of a scan function (such as the page continuous copy function) which is not supported by the general-purpose scan software 202 but is supported by the scan device 102 and the extension application 204 is added to the scan function information 203.

Referring to FIG. 12, the above-described steps S601 to S612 are executed. Then, in a step S1201, the general-purpose scan software 202 generates a scan instruction command. Note that in the scan instruction command generated in the step S1201, a setting of a scan function, such as the page continuous copy function, which is not supported by the general-purpose scan software 202 is not included.

Then, in a step S1202, the general-purpose scan software 202 transmits the generated scan instruction command to the extension application 204.

Then, in a step S1203, the extension application 204 edits the received scan instruction command. Specifically, the extension application 204 adds an instruction command for a scan function which is not supported by the general-purpose scan software 202 and changes the existing instruction, on the received scan instruction command. Here, in the scan instruction command generated by the general-purpose scan software 202 in the step S1201, a setting of the page continuous copy function, which has been made on the detailed setting screen 305b, is not included. Therefore, in the step S1203, the setting of the page continuous copy function is added to the received scan instruction command. The scan instruction command obtained in the step S1203 is hereinafter referred to as the function-extended scan instruction command.

Then, in a step S1204, the extension application 204 transmits the function-extended scan instruction command to the general-purpose scan software 202.

In a step S1205, the general-purpose scan software 202 transmits the function-extended scan instruction command to the scan device 102. Then, the above-described step S616 is executed, and the scan device 102 interprets the function-extended scan instruction command and executes scan processing.

Then, in a step S1206, the scan device 102 transmits the generated image data to the general-purpose scan software 202. Then, the above-described steps S619 to S621 are executed, followed by terminating the present process.

In the above-described third embodiment, the extension application 204 adds the setting of the page continuous copy function, which has been made on the detailed setting screen 305b, to the scan instruction command generated by the general-purpose scan software 202. With this, it is possible to cause the scan device 102 to execute the scan processing based on the setting of the page continuous copy function, which has been made on the detailed setting screen 305b, and as a result, it is possible to provide image data divided by this scan processing to the user.

Next, a program, a communication system, an information processing apparatus, and a method of controlling the information processing apparatus, according to a fourth embodiment, will be described. The fourth embodiment has basically the same configuration and effects as the above-described first embodiment. However, the fourth embodiment is different from the first embodiment in that the extension application 204 edits a scan instruction command generated by the general-purpose scan software 202, and the scan device 102 does not support the page continuous copy function. Therefore, description of the redundant configuration and effects is omitted, and the following description will be given of different configuration points and effects.

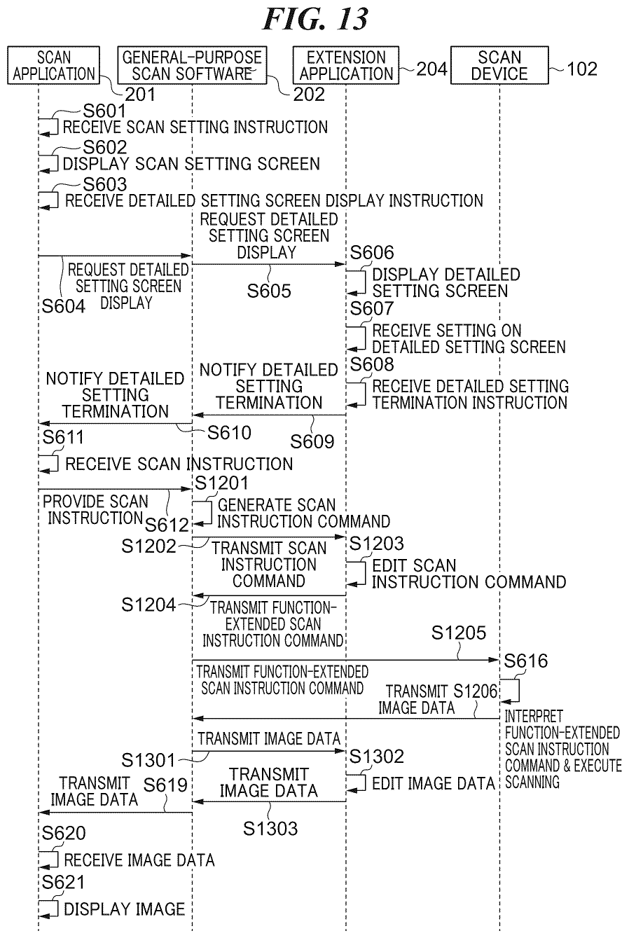

FIG. 13 is a sequence diagram of a scan control process performed in the communication system according to the fourth embodiment. Note that in the fourth embodiment, the scan device 102 does not support the page continuous copy function. The scan control process in FIG. 13 is similar to the above-described scan control processes in FIGS. 10 and 12, and the following description will be particularly given of different points from the above-described scan control processes in FIGS. 10 and 12. The processing operations performed by the host computer 101 in FIG. 13 are realized by the CPU 111 that loads the respective programs of the scan application 201, the general-purpose scan software 202, and the extension application 204 from the external storage device 114 into the RAM 113 and executes the loaded programs. Further, the processing operations performed by the scan device 102 in FIG. 13 are realized by the CPU 191 of the scan device 102, which loads the program stored in the ROM 192 or the external storage device 199 into the RAM 193 and executes the loaded program. Note that also in the scan control process in FIG. 13, as described with reference to FIG. 2B, the scan control process performed by the host computer 101 configured to include the extension application 204, will be described. Further, note that in the scan control process in FIG. 13, it is assumed that the above-described edit control process in FIG. 9 has already been executed. By this edit control process, an option of the page continuous copy function which is not supported by the general-purpose scan software 202 and the scan device 102 but is supported by the extension application 204 is added to the scan function information 203.

Referring to FIG. 13, first, the above-described steps S601 to S612 are executed, and then, the above-described steps S1201 to S1205, S616, and S1206 are executed. Note that in the fourth embodiment, the scan instruction command obtained by the editing in the step S1203 does not include a setting of the page continuous copy function which is not supported by the scan device 102 but is supported by the extension application 204, but this is not limitative. In a case where the scan device 102 does not support the page continuous copy function, even when the scan device 102 acquires a scan instruction command including a setting of the page continuous copy function, the scan device 102 cannot interpret the setting of the page continuous copy function. The scan device 102 performs scan processing based on settings other than the setting of the page continuous copy function out of the settings included in the scan instruction command. Thus, in the scan device 102 which does not support the page continuous copy function, even if a scan instruction command including a setting of the page continuous copy function is acquired, the same scan processing as in a case where a scan instruction command which does not include a setting of the page continuous copy function is acquired is executed. Therefore, in the fourth embodiment, the scan instruction command obtained by the editing in the step S1203 can include a setting of the page continuous copy function.

Then, in a step S1301, the general-purpose scan software 202 transmits image data received from the scan device 102 to the extension application 204.

Then, in a step S1302, similar to the step S1002, the extension application 204 causes the image data-editing unit 207 to edit the image data received from the scan device 102. For example, the image data-editing unit 207 divides the image data received from the scan device 102 into two image data, specifically, image data of the left page and image data of the right page.

Then, in a step S1303, the extension application 204 transmits the image data obtained in the step S1302 to the general-purpose scan software 202. After that, the above-described steps S619 to the step S621 are executed.

In this configuration in the fourth embodiment as well, the user is also enabled to use the page continuous copy function.

Next, a program, a communication system, an information processing apparatus, and a method of controlling the information processing apparatus, according to a fifth embodiment, will be described. The fifth embodiment has basically the same configuration and effects as the above-described first embodiment but is different from the first embodiment in that a standard scan instruction command based on the standard protocol is not extended but an extended scan instruction command is separately generated. Therefore, description of the redundant configuration and effects is omitted, and the following description will be given of different configuration points and effects.

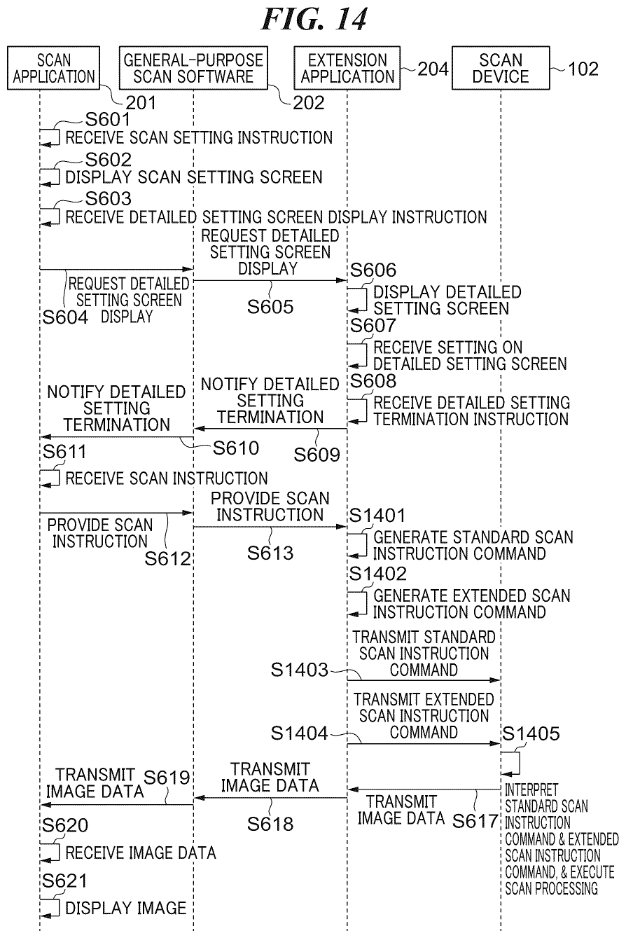

FIG. 14 is a sequence diagram of a scan control process performed in the communication system according to the fifth embodiment. Note that the scan control process in FIG. 14 is similar to the above-described scan control process in FIG. 6, and the following description will be given of different points from the above-described scan control process in FIG. 6. The processing operations performed by the host computer 101 in FIG. 14 are realized by the CPU 111 that loads the respective programs of the scan application 201, the general-purpose scan software 202, and the extension application 204 from the external storage device 114 into the RAM 113 and executes the loaded programs. Further, the processing operations performed by the scan device 102 in FIG. 14 are realized by the CPU 191 of the scan device 102, which loads the program stored in the ROM 192 or the external storage device 199 into the RAM 193 and executes the loaded program. Note that also in the scan control process in FIG. 14, as described hereinabove with reference to FIG. 2B, the scan control process performed by the host computer 101 configured to include the extension application 204, will be described. Further, note that in the scan control process in FIG. 14 as well, it is assumed that the above-described edit control process in FIG. 4 has already been executed. By this edit control process, an option of a scan function (such as the page continuous copy function) which is not supported by the general-purpose scan software 202 but is supported by the scan device 102 and the extension application 204 is added to the scan function information 203.

Referring to FIG. 14, first, the above-described steps S601 to S613 are executed. Then, in a step S1401, the extension application 204 generates a standard scan instruction command according to the standard protocol. Note that in the standard scan instruction command generated in the step S1401, a scan function which is not supported by the standard protocol is not recorded. For example, in a case where the page continuous copy function is not supported by the standard protocol, a setting of the page continuous copy function, which has been made on the detailed setting screen 305b, is not included in the standard scan instruction command.

Then, in a step S1402, the extension application 204 generates an extended scan instruction command for realizing the scan function which is not supported by the standard protocol. In the extended scan instruction command, a setting of the scan function which is not supported by the standard protocol but is supported by the extension application 204 is included. For example, in a case where the page continuous copy function is not supported by the standard protocol, a setting of the page continuous copy function, which has been made on the detailed setting screen 305b, is included in the extended scan instruction command.

Then, in a step S1403, the extension application 204 transmits the standard scan instruction command to the scan device 102. Further, in a step S1404, the extension application 204 transmits the extended scan instruction command to the scan device 102.

Then, in a step S1405, the scan device 102 interprets the received standard scan instruction command and extended scan instruction command, respectively, and executes scan processing. After that, the above-described steps S617 to S621 are executed, followed by terminating the present process.

Here, the scan instruction command generation process performed by the extension application 204 in the fifth embodiment will be described. This scan instruction command generation process includes the above-described processing operations in the respective steps S606, S607, S608, S609, S1401, S1402, S1403, S1404, and S618.

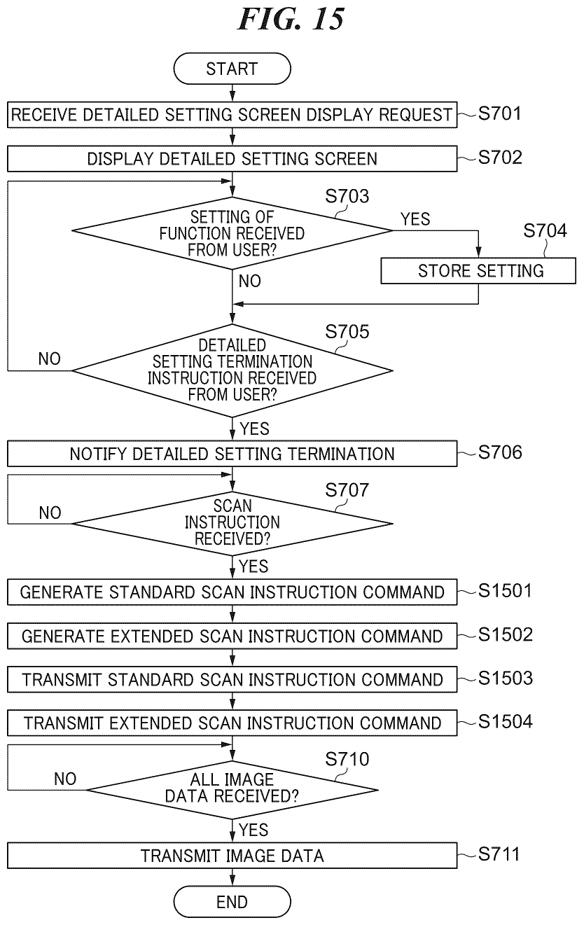

FIG. 15 is a flowchart of the scan instruction command generation process performed by the extension application 204 of the fifth embodiment. Note that the scan instruction command generation process in FIG. 15 is similar to the above-described scan instruction command generation process in FIG. 7, and the following description will be particularly given of different points from the above-described scan instruction command generation process in FIG. 7. Similar to the above-described scan instruction command generation process in FIG. 7, the scan instruction command generation process in FIG. 15 is also realized by the CPU 111 that executes a program of the extension application 204, which is loaded from the external storage device 114 into the RAM 113.

Referring to FIG. 15, the above-described steps S701 to S707 are executed. When a scan instruction has been received (YES in S707), in a step S1501, the extension application 204 generates a standard scan instruction command according to the standard protocol (see e.g. the above-described step S1401). Then, in a step S1502, the extension application 204 generates an extended scan instruction command for realizing a scan function which is not supported by the standard protocol (see e.g. the above-described step S1402). Then, in a step S1503, the extension application 204 transmits the standard scan instruction command generated in the step S1501 to the scan device 102 (see e.g.

the above-described step S1403). Then, in a step S1504, the extension application 204 transmits the extended scan instruction command generated in the step S1502 to the scan device 102 (see e.g. the above-described step S1404). After that, the above-described steps S710 and S711 are executed, followed by terminating the present process.

In the above-described fifth embodiment, the standard scan instruction command based on the standard protocol and the extended scan instruction command for realizing a scan function which is not supported by the standard protocol are transmitted to the scan device 102, respectively. With this, it is possible to reflect the setting of the scan function which is not supported by the standard protocol on the scan instruction command.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-066655 filed Apr. 17, 2024, which is hereby incorporated by reference herein in its entirety.

What is claimed is:

1. A non-transitory computer-readable storage medium storing a program supporting a general-purpose program which can be commonly used for scanners of a plurality of makers, the program being executed to thereby execute a method of controlling an information processing apparatus in which the program is installed,
the method comprising:
displaying, on a display unit of the information processing apparatus, a setting screen for receiving a setting of a predetermined scan function that divides image data of a read image of one original into a plurality of image data and outputs the divided image data; and
outputting a command for causing a scanner to execute scan processing based on the setting received on the setting screen.

2. The storage medium according to claim 1, wherein on the setting screen, a setting for determining a page order of divided image data is made by a user.

3. The storage medium according to claim 2, wherein the method further comprises receiving the plurality of image data generated by the scan processing from the scanner, and
wherein numbers corresponding to an order of pages, which are determined according to the setting, are added to file names of the plurality of received image data, respectively.

4. The storage medium according to claim 1, wherein the method further comprises receiving one image file including the plurality of image data generated by the scan processing from the scanner, and
wherein generation date and time of the image file are added to a file name of the received image file.

5. The storage medium according to claim 1, wherein in the scan processing using the predetermined scan function, reading of one original is performed a plurality of times.

6. The storage medium according to claim 1, wherein the method further comprises:
determining whether or not a scanner designated by a user supports the predetermined scan function, and
performing edit processing for dividing acquired image data into a plurality of image data, and
wherein the edit processing includes, in a case where it is determined that the scanner designated by the user does not support the predetermined scan function, dividing one image data generated by the scan processing executed by the scanner designated by the user according to the command into a plurality of image data.

7. The storage medium according to claim 6, wherein the outputting of the command includes, in a case where it is determined that the scanner designated by the user does not support the predetermined scan function, outputting a command which does not include the setting received on the setting screen.

8. The storage medium according to claim 1, wherein the method further comprises performing control to restrict, in a case where a setting of another function mismatching the predetermined scan function is made, reception of the setting of the predetermined scan function.

9. The storage medium according to claim 1, wherein the method further comprises generating a command for causing the scanner to execute the scan processing based on the setting received on the setting screen.

10. The storage medium according to claim 9, wherein the command is a command generated by extending a function to a command based on a standard protocol.

11. The storage medium according to claim 9, wherein the command is a command generated by converting a command based on a standard protocol to a command system specific to the program.

12. The storage medium according to claim 9, wherein the generating includes outputting a first command based on a standard protocol and a second command including the setting received on the setting screen.

13. The storage medium according to claim 1, wherein the method further comprises editing a command generated by the general-purpose program, for causing the scanner to execute the scan processing, and
wherein the editing includes adding the setting received on the setting screen to the command generated by the general-purpose program, for causing the scanner to execute the scan processing.

14. The storage medium according to claim 1, wherein a setting item displayed on the setting screen is determined by using capabilities information of a scanner designated by a user.

15. The storage medium according to claim 1, wherein a setting item displayed on the setting screen is determined by using capabilities information of an application operated by executing the program.

16. The storage medium according to claim 1, wherein the setting screen includes an item for setting a data format of image data.

17. The storage medium according to claim 1, wherein the method further comprises receiving image data generated by the scan processing from the scanner, and
displaying the image data on the display unit of the information processing apparatus.

18. A method of controlling an information processing apparatus in which a program supporting a general-purpose program which can be commonly used for scanners of a plurality of makers has been installed, comprising:
displaying a setting screen for receiving a setting of a predetermined scan function that divides image data of a read image of one original into a plurality of image data, on a display unit of the information processing apparatus; and
outputting a command for causing a scanner to execute scan processing based on the setting received on the setting screen.

19. An information processing apparatus in which a program supporting a general-purpose program which can be commonly used for scanners of a plurality of makers has been installed, comprising:
a unit configured to display a setting screen for receiving a setting of a predetermined scan function that divides image data of a read image of one original into a plurality of data; and
a unit configured to output a command for causing a scanner to execute scan processing based on the setting received on the setting screen.
